(19) United States
(12) Patent Application Publication
(10) Pub. No.: US 2023/0352755 A1
(43) Pub. Date: Nov. 2, 2023

(54) SYSTEMS AND METHODS FOR ELECTROCHEMICAL CELL MATERIAL RECYCLING

(71) Applicant: 24M Technologies, Inc., Cambridge, MA (US)

(72) Inventors: Ruben D. ARAGON, Cambridge, MA (US); Matthew R. TYLER, Boston, MA (US); Kypros D. PANTELI, Quincy, MA (US); Hasan SIDDIQUI, Chelsea, MA (US); Evan RUGEN, Waltham, MA (US); Gregory MEHOS, Westford, MA (US); Junzheng CHEN, Concord, MA (US); Ashley MORISHIGE, Watertown, MA (US); Christian EBNER, Roxbury, MA (US)

(21) Appl. No.: 18/128,452

(22) Filed: Mar. 30, 2023

Related U.S. Application Data
(60) Provisional application No. 63/325,311, filed on Mar. 30, 2022.

(51) Int. Cl. H01M 10/54

(52) U.S. Cl. CPC H01M 10/54

(57) ABSTRACT

Embodiments described herein relate to recycling of electrochemical cell materials. In some aspects, a method can include separating a stack pouch material from an electrochemical cell stack, separating a plurality of unit cells from the electrochemical cell stack into individual unit cells, cutting within a heat seal of a cell pouch of a unit cell from the plurality of unit cells, separating a cathode material and a cathode current collector away from a separator, an anode material, and an anode current collector of the unit cell, placing the cathode material and the cathode current collector in a solvent bath with the cathode current collector facing downward, separating the cathode material from the cathode current collector via an ultrasonic probe, separating solids and liquids of the cathode material, drying the solids of the cathode material, and incorporating the solids of the cathode material into a new cathode mixture.

### CROSS REFERENCE TO RELATED APPLICATIONS

This application claims the benefit of U.S. Provisional Application No. 63/325,311, titled “Systems and Methods for Electrochemical Cell Material Recycling,” and filed Mar. 30, 2022, the content of which is incorporated herein by reference in its entirety.

### TECHNICAL FIELD

Embodiments described herein relate to recycling of electrochemical cell material.

### BACKGROUND

Electrochemical cells can be produced with a wide range of active materials, conductive materials, and/or electrolytes. Active materials, conductive materials, and electrolytes can be combined to form a semi-solid electrode material. Disposal of semi-solid electrodes can be costly for several reasons. First, it can be necessary to add expensive chemicals to quench the active materials to make them non-hazardous. Additionally, the active materials, conductive materials, and electrolytes may still be at least partially usable. The value of that material is therefore lost. Recycling electrode materials can greatly reduce the impact of these costs. Current lithium-ion recycling processes include pyro-hydrometallurgical recycling processes and mechanical-hydrometallurgical recycling processes. Both of these types of processes can obtain products in pure elementary form. These processes also use a significant amount of energy and resources to separate and isolate specific battery materials from each other. This is a disadvantage, as they require additional processes to re-synthesize and form raw battery compounds to re-incorporate into the production process.

### SUMMARY

Embodiments described herein relate to recycling of electrochemical cell materials. In some aspects, a method of recycling electrode materials can include separating a stack pouch material from an electrochemical cell stack, separating a plurality of unit cells from the electrochemical cell stack into individual unit cells, cutting within a heat seal of a cell pouch of a unit cell from the plurality of unit cells, separating a cathode material and a cathode current collector away from a separator via an ultrasonic probe, an anode material, and an anode current collector of the unit cell, placing the cathode material and the cathode current collector in a solvent bath with the cathode current collector facing downward, separating the cathode material from the cathode current collector, separating solids and liquids of the cathode material, drying the solids of the cathode material, and incorporating the solids of the cathode material into a new cathode mixture.

In some aspects, a method of producing a recycled electrode material can include separating a stack pouch material from an electrochemical cell stack, separating a plurality of unit cells from the electrochemical cell stack into individual unit cells, cutting within a heat seal of a cell pouch of a unit cell from the plurality of unit cells, separating an anode material and an anode current collector away from a separator, a cathode material, and a cathode current collector of the unit cell, placing the anode material and the anode current collector in a solvent bath with the anode current collector facing downward, separating the anode material from the anode current collector via an ultrasonic probe, separating solids and liquids of the anode material, drying the solids of the anode material; and incorporating the solids of the anode material into a new anode mixture.

In some aspects, a method can include cutting a portion of a separator and a cell pouch material, separating the pouch material from an electrochemical cell, cutting the electrochemical cell into electrodes and a separator, the electrodes including two electrode materials coupled to current collectors, separating the electrode materials from their respective current collectors, rinsing the electrode materials with electrolyte solvent to dissolve and separate electrolyte salt from the electrode materials, drying the electrode materials, and reintroducing the electrode materials into an electrochemical cell production process. In some embodiments, drying the electrode materials can be via centrifugation, filtration, heat drying, or any combination thereof. In some embodiments, the method can include mixing the recycled electrode material with a fresh electrode material. In some embodiments, the method can include tuning the mass:mass ratio between the recycled electrode material and the fresh electrode material. In some embodiments, the method can include adjusting the mass:mass ratio between active and conductive material in the recycled electrode material.

In some aspects, a method can include mixing a semi-solid electrode material with a solvent to produce an electrode slurry. The semi-solid electrode material includes an active material and a conductive material in an electrolyte solution. The method further includes feeding the electrode slurry to a froth flotation vessel, and feeding a gas into the froth flotation vessel, such that at least about 80% by mass of the conductive material collects in a froth at the top of the froth flotation vessel. The froth is separate from a liquid phase in a froth flotation vessel. The method further includes separating the froth from the liquid phase, draining the liquid phase from the froth flotation vessel, and drying the liquid phase to separate the active material from the liquid phase. In some embodiments, the method can include separating a semi-solid electrode from a current collector and feeding the semi-solid electrode to the electrode slurry. In some embodiments, separating the semi-solid electrode from the current collector can be via a solvent bath with sonication.

### BRIEF DESCRIPTION OF THE DRAWINGS

FIG. 1 is a block diagram of a system for recycling electrode materials, according to an embodiment.

FIG. 2 is a block diagram of a system for recycling electrode materials, according to an embodiment.

FIG. 3 is a block diagram of a system for recycling electrode materials, according to an embodiment.

FIG. 4 is an illustration of a froth flotation vessel, according to an embodiment.

FIG. 5 is an illustration of a magnet, according to an embodiment.

FIG. 6 is a block diagram of a method of recycling electrode materials, according to an embodiment.

FIG. 7 is a block diagram of a method of recycling electrode materials, according to an embodiment.

FIG. 8 is a block diagram of a method of recycling electrode materials, according to an embodiment.

FIG. 9 is a block diagram of a system for recycling electrode materials, according to an embodiment.

FIG. 10 is a block diagram of a method of recycling electrode materials, according to an embodiment.

FIGS. 11A-11D are illustrations of a method of recycling electrode materials and various aspects thereof, according to an embodiment.

FIG. 12 is a block diagram of a method of recycling electrode materials, according to an embodiment.

FIG. 13 shows electrode material performance data using fresh conductive powder vs. sonicated conductive powder.

FIG. 14 shows charge capacities of electrochemical cells made using fresh electrode materials, compared against those made using recycled electrode materials.

### DETAILED DESCRIPTION

Embodiments described herein relate to electrode and electrochemical cell material recycling. Electrode material recycled using methods described herein can originate from waste materials from the electrochemical cell production process. In some embodiments, methods described herein can be used to recycle electrode materials (i.e., anode materials and/or cathode materials) after a slurry mix process but before a formation and aging process. Recycling electrode materials can save significant costs, both for quenching chemicals and for the costs of the materials themselves. Separation processes described herein include centrifuge separation, settler separation, flocculant separation, froth flotation, hydro cyclone, vibratory screening, air classification, and magnetic separation. In some embodiments, methods described herein can include any combination of froth flotation, air classification, and magnetic separation. In some embodiments, electrolyte can be separated from active and/or conductive materials via drying, subcritical or supercritical carbon dioxide extraction, solvent mass extraction (e.g., with non-aqueous or aqueous solvents), and/or freeze-drying. By applying these separation processes, high purity raw products can be isolated. These products can be re-used or sold to a third party. Processes described herein are scalable to large cell production facilities.

Semi-solid electrodes described herein can be made: (i) thicker (e.g., greater than 100 µm - up to 2,000 µm or even greater) due to the reduced tortuosity and higher electronic conductivity of the semi-solid electrode, (ii) with higher loadings of active materials, and (iii) with a simplified manufacturing process utilizing less equipment. These relatively thick semi-solid electrodes decrease the volume, mass and cost contributions of inactive components with respect to active components, thereby enhancing the commercial appeal of batteries made with the semi-solid electrodes. In some embodiments, the semi-solid electrodes described herein are binderless and/or do not use binders that are used in conventional battery manufacturing. Instead, the volume of the electrode normally occupied by binders in conventional electrodes, is now occupied by: 1) electrolyte, which has the effect of decreasing tortuosity and increasing the total salt available for ion diffusion, thereby countering the salt depletion effects typical of thick conventional electrodes when used at high rate, 2) active material, which has the effect of increasing the charge capacity of the battery, or 3) conductive additive, which has the effect of increasing the electronic conductivity of the electrode, thereby countering the high internal impedance of thick conventional electrodes. The reduced tortuosity and a higher electronic conductivity of the semi-solid electrodes described herein, results in superior rate capability and charge capacity of electrochemical cells formed from the semi-solid electrodes. Since the semi-solid electrodes described herein, can be made substantially thicker than conventional electrodes, the ratio of active materials (i.e., the semi-solid cathode and/or anode) to inactive materials (i.e., the current collector and separator) can be much higher in a battery formed from electrochemical cell stacks that include semi-solid electrodes relative to a similar battery formed form electrochemical cell stacks that include conventional electrodes. This substantially increases the overall charge capacity and energy density of a battery that includes the semi-solid electrodes described herein.

In some embodiments, the electrode materials described herein can be a flowable semi-solid or condensed liquid composition. In some embodiments, the electrode materials described herein can be binderless or substantially free of binder. A flowable semi-solid electrode can include a suspension of an electrochemically active material (anodic or cathodic particles or particulates), and optionally an electronically conductive material (e.g., carbon) in a non-aqueous liquid electrolyte. Said another way, the active electrode particles and conductive particles are co-suspended in an electrolyte to produce a semi-solid electrode. The electrolyte can include an electrolyte solvent and an electrolyte salt. In some embodiments, the electrolyte solvent can include vinylene carbonate (VC), 1,3 propane sultone (PS), ethyl propionate (EP), 1,3-propanediol cyclic sulfate (PSA/TS), fluoroethylene carbonate (FEC), ethylene sulfite (ES), tris(2-ethylhexyl) phosphate (TOP), ethylene sulfate (DTD), diethyl carbonate (DEC), lithium difluorophosphate (LiPF₂O₂), butyl sultone (BuS), ethyl acetate (EA), maleic anhydride (MA), ethylene carbonate (EC), propylene carbonate (PC), dimethyl carbonate (DMC), ethyl methyl carbonate (EMC), or combinations thereof. In some embodiments, the electrolyte salt can include lithium bis(oxalate) borate (LiBOB), lithium hexafluorophosphate (LiPF₆), lithium bis(fluorosulfonyl)imide (LiFSI), or any combination thereof. Examples of battery architectures utilizing semi-solid suspensions are described in International Patent Publication No. WO 2012/024499 (“the ‘499 publication”), filed Aug. 18, 2011 and titled “Stationary, Fluid Redox Electrode,” International Patent Publication No. WO 2012/088442 (“the ‘442 publication”), filed Dec. 22, 2011, and titled “Semi-Solid Filled Battery and Method of Manufacture,” U.S. Pat. No. 10,181,587 (“the ‘587 patent”), filed Jun. 17, 2016 and titled “Single Pouch Battery Cells and Methods of Manufacture,” U.S. Pat. No. 10,734,672 (“the ‘672 patent”), filed Jan. 8, 2019 and titled “Electrochemical Cells Including Selectively Permeable Membranes, Systems and Methods of Manufacturing the Same,” U.S. Pat. Publication No. 2022/0115710 (“the ‘710 publication”), filed Oct. 12, 2021, and titled “Methods of Continuous and Semi-Continuous Production of Electrochemical Cells,” and U.S. Pat. Publication No. 2022/0238923 (“the ‘923 publication”), filed Jan. 21, 2022 and titled “Production of Semi-Solid Electrodes via Addition of Electrolyte to Mixture of Active Material, Conductive Material, and Electrolyte Solvent,” the entire disclosures of which are hereby incorporated by reference. Examples of electrode materials that can be recycled are described in U.S. Provisional Pat. Application No. 63/354,056, filed Jun. 21, 2022 and titled “Electrochemical Cells with High-Viscosity Semi-Solid Electrodes, and Methods of Making the Same,” the entire disclosure of which is hereby incorporated by reference.

Embodiments described herein can lead to a reduction of processing waste material. This can increase process material yield and reduce cost of operation. Processes described herein can lead to a reduction in disposal of waste material. Material recovered from semi-solid electrodes and reintroduced into the production process can be ready to use in lithium-ion cell production. In some embodiments, recovered electrode material can be mixed with fresh electrode material in the production process. Proper characterization of a semi-solid electrode material can be important for identifying limits of operation for in-process recycling. Proper specification of raw material can be important for meeting process needs for recycling of products. Embodiments described herein feature a shorter recovery route and a lower energy consumption of raw material for semi-solid electrode production compared to pyrometallurgical processes and hydrometallurgical processes. In-process recycling of semi-solid electrode material can be implemented in an individual process slurry (i.e., anode or cathode) and combined inlet material (i.e., anode and cathode).

Further examples of cell remediation methods are described in U.S. Pat. No. 10,511,310 (“the ‘310 patent”), filed Jun. 20, 2016, titled, “Methods for Electrochemical Cell Remediation,” the entire disclosure of which is hereby incorporated by reference in its entirety.

As used in this specification, the singular forms “a,” “an,” and “the” include plural referents unless the context clearly dictates otherwise. Thus, for example, the term “a member” is intended to mean a single member or a combination of members, “a material” is intended to mean one or more materials, or a combination thereof.

The term “substantially” when used in connection with “cylindrical,” “linear,” and/or other geometric relationships is intended to convey that the structure so defined is nominally cylindrical, linear or the like. As one example, a portion of a support member that is described as being “substantially linear” is intended to convey that, although linearity of the portion is desirable, some non-linearity can occur in a “substantially linear” portion. Such non-linearity can result from manufacturing tolerances, or other practical considerations (such as, for example, the pressure or force applied to the support member). Thus, a geometric construction modified by the term “substantially” includes such geometric properties within a tolerance of plus or minus 5% of the stated geometric construction. For example, a “substantially linear” portion is a portion that defines an axis or center line that is within plus or minus 5% of being linear.

As used herein, the term “set” and “plurality” can refer to multiple features or a singular feature with multiple parts. For example, when referring to a set of electrodes, the set of electrodes can be considered as one electrode with multiple portions, or the set of electrodes can be considered as multiple, distinct electrodes. Additionally, for example, when referring to a plurality of electrochemical cells, the plurality of electrochemical cells can be considered as multiple, distinct electrochemical cells or as one electrochemical cell with multiple portions. Thus, a set of portions or a plurality of portions may include multiple portions that are either continuous or discontinuous from each other. A plurality of particles or a plurality of materials can also be fabricated from multiple items that are produced separately and are later joined together (e.g., via mixing, an adhesive, or any suitable method).

As used herein, the term “semi-solid” refers to a material that is a mixture of liquid and solid phases, for example, such as a particle suspension, a slurry, a colloidal suspension, an emulsion, a gel, or a micelle.

As used herein, the terms “activated carbon network” and “networked carbon” relate to a general qualitative state of an electrode. For example, an electrode with an activated carbon network (or networked carbon) is such that the carbon particles within the electrode assume an individual particle morphology and arrangement with respect to each other that facilitates electrical contact and electrical conductivity between particles and through the thickness and length of the electrode. Conversely, the terms “unactivated carbon network” and “unnetworked carbon” relate to an electrode wherein the carbon particles either exist as individual particle islands or multi-particle agglomerate islands that may not be sufficiently connected to provide adequate electrical conduction through the electrode.

As used herein, the terms “energy density” and “volumetric energy density” refer to the amount of energy (e.g., MJ) stored in an electrochemical cell per unit volume (e.g., L) of the materials included for the electrochemical cell to operate such as, the electrodes, the separator, the electrolyte, and the current collectors. Specifically, the materials used for packaging the electrochemical cell are excluded from the calculation of volumetric energy density.

As used herein, the terms “high-capacity materials” or “high-capacity anode materials” refer to materials with irreversible capacities greater than 300 mAh/g that can be incorporated into an electrode in order to facilitate uptake of electroactive species. Examples include tin, tin alloy such as Sn—Fe, tin mono oxide, silicon, silicon alloy such as Si—Co, silicon monoxide, aluminum, aluminum alloy, mono oxide metal (CoO, FeO, etc.) or titanium oxide.

As used herein, the term “composite high-capacity electrode layer” refers to an electrode layer with both a high-capacity material and a traditional anode material, e.g., a silicon-graphite layer.

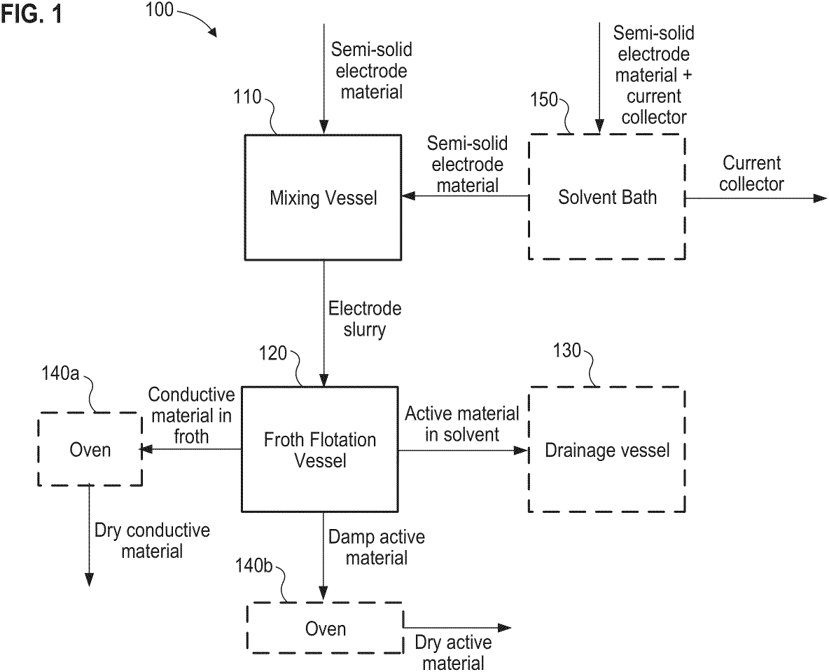

As used herein, the term “solid high-capacity electrode layer” refers to an electrode layer with a single solid phase high-capacity material, e.g., sputtered silicon, tin, tin alloy such as Sn—Fe, tin mono oxide, silicon, silicon alloy such as Si—Co, silicon monoxide, aluminum, aluminum alloy, mono oxide metal (CoO, FeO, etc.) or titanium oxide. FIG. 1 is a block diagram of a system 100 for recycling electrode materials, according to an embodiment. As shown, the system 100 includes a mixing vessel 110 and a froth flotation vessel 120. The system 100 optionally includes a drainage vessel 130, ovens 140a, 140b, and a solvent bath 150. During operation, a first amount of semi-solid electrode material is fed to the mixing vessel 110. Optionally, a second amount of semi-solid electrode material coupled to a current collector can be fed to the solvent bath 150 where the second amount of semi-solid electrode material is separated from the current collector. The second amount of semi-solid electrode material is then fed to the mixing vessel 110, where semi-solid electrode material is mixed with a solvent to form an electrode slurry. The electrode slurry is then fed to the froth flotation vessel 120, where the conductive material in a froth is separated from the active material in a solvent. The conductive material and the froth can be heated in the oven 140a to vaporize solvent and separate dry conductive material from the solvent. The active material in the solvent is optionally fed to a drainage vessel where a majority of the solvent is drained to form a damp active material. The damp active material is fed to the oven 140b, where the solvent is vaporized and the dry active material can be isolated.

The mixing vessel 110 is used for mixing and churning used semi-solid electrode material. In some embodiments, the contents mixed in the mixing vessel 110 can include unused semi-solid electrode material that were not incorporated into an electrochemical cell (i.e., the semi-solid electrode material was not coupled to a current collector). In some embodiments, semi-solid electrode material can be scraped off of one or more current collectors and fed to the mixing vessel 110. In some embodiments, the semi-solid electrode material can be separated via the solvent bath 150. In some embodiments, the mixing vessel 110 can include a mixing arm and/or an impeller. In the mixing vessel 110, a solvent is added to form the semi-solid electrode material into an electrode slurry. In some embodiments, the solvent can include water. In some embodiments, the solvent can include VC, PS, EP, PSA/TS, FEC, ES, TOP, DTD, EA, MA, EC, PC, DMC, EMC, or combinations thereof. In some embodiments, the solvent can include a salt dissolved therein. In some embodiments, the salt can include LiBOB, LiPF₆, LiFSI, or any combination thereof. In some embodiments, the solvent can include acetone, one or more alcohols, methanol, ethanol, isopropanol, butanol, or any other suitable solvent.

In some embodiments, the mixing vessel 110 can have a volume of at least about 1 L, at least about 5 L, at least about 10 L, at least about 50 L, at least about 100 L, at least about 500 L, at least about 1 m³, at least about 5 m³, at least about 10 m³, at least about 50 m³, at least about 100 m³, or at least about 500 m³. In some embodiments, the mixing vessel 110 can have a volume of no more than about 1,000 m³, no more than about 500 m³, no more than about 100 m³, no more than about 50 m³, no more than about 10 m³, no more than about 5 m³, no more than about 1 m³, no more than about 500 L, no more than about 100 L, no more than about 50 L, no more than about 10 L, or no more than about 5 L. Combinations of the above-referenced volumes of the mixing vessel 110 are also possible (e.g., at least about 1 L and no more than about 1,000 m³ or at least about 50 L and no more than about 1 m³), inclusive of all values and ranges therebetween. In some embodiments, the mixing vessel 110 can have a volume of about 1 L, about 5 L, about 10 L, about 50 L, about 100 L, about 500 L, about 1 m³, about 5 m³, about 10 m³, about 50 m³, about 100 m³, about 500 m³, or about 1,000 m³.

The froth flotation vessel 120 receives electrode slurry from the mixing vessel 110. The differences in hydrophobicity of the materials in the electrode slurry aid in the separation process. Air and pulp can be fed into the froth flotation vessel 120 to induce bubbling. Conductive material with hydrophobic properties can bond to bubbles in the froth flotation vessel 120 and float to the top of the froth flotation vessel 120. In some embodiments, the froth flotation process can be enhanced using frother and collectors. Conductive material can be hydrophilic and stay dissolved and/or suspended in a water-based solvent in the liquid phase of the froth flotation vessel 120.

In some embodiments, the froth flotation vessel 120 can have a volume of at least about 1 L, at least about 5 L, at least about 10 L, at least about 50 L, at least about 100 L, at least about 500 L, at least about 1 m³, at least about 5 m³, at least about 10 m³, at least about 50 m³, at least about 100 m³, or at least about 500 m³. In some embodiments, the froth flotation vessel 120 can have a volume of no more than about 1,000 m³, no more than about 500 m³, no more than about 100 m³, no more than about 50 m³, no more than about 10 m³, no more than about 5 m³, no more than about 1 m³, no more than about 500 L, no more than about 100 L, no more than about 50 L, no more than about 10 L, or no more than about 5 L. Combinations of the above-referenced volumes of the froth flotation vessel 120 are also possible (e.g., at least about 1 L and no more than about 1,000 m³ or at least about 50 L and no more than about 1 m³), inclusive of all values and ranges therebetween. In some embodiments, the froth flotation vessel 120 can have a volume of about 1 L, about 5 L, about 10 L, about 50 L, about 100 L, about 500 L, about 1 m³, about 5 m³, about 10 m³, about 50 m³, about 100 m³, about 500 m³, or about 1,000 m³. In some embodiments, the system 100 can include a flocculation vessel (not shown) and/or a gravity settling tank (not shown) instead of or in addition to the froth flotation vessel 120.

The drainage vessel 130 is optional and can be a separate vessel from the froth flotation vessel 120 for capturing the combination of active material and solvent. The drainage vessel 130 can be fed from a drain in the froth flotation vessel (e.g., via a series of pipes or tubes). In some embodiments, the active material and solvent can be pumped into the drainage vessel 130. In some embodiments, the drainage vessel 130 can include a mesh and/or filter for separating solid from liquid.

The oven 140a vaporizes liquid from the conductive material/solvent mixture, leaving behind dry powder. In some embodiments, the froth material fed to the oven 140a can include both conductive material and active material. In some embodiments, dry conductive material powder can be reused. In some embodiments, the dry conductive material powder can be combined with fresh conductive material and reused. In some embodiments, dry conductive material powder can be packaged and sold to a third party. In some embodiments, the oven 140a can be heated to a temperature of at least about 30° C., at least about 40° C., at least about 50° C., at least about 60° C., at least about 70° C., at least about 80° C., at least about 90° C., at least about 100° C., at least about 150° C., at least about 200° C., at least about 250° C., at least about 300° C., at least about 350° C., at least about 400° C., or at least about 450° C. In some embodiments, the oven 140a can be heated to a temperature of no more than about 500° C., no more than about 450° C., no more than about 400° C., no more than about 350° C., no more than about 300° C., no more than about 250° C., no more than about 200° C., no more than about 150° C., no more than about 100° C., no more than about 90° C., no more than about 80° C., no more than about 70° C., no more than about 60° C., no more than about 50° C., or no more than about 40° C.

Combinations of the above-referenced temperatures are also possible (e.g., at least about 30° C. and no more than 500° C. or at least about 100° C. and no more than about 300° C.), inclusive of all values and ranges therebetween. In some embodiments, the oven 140a can be heated to a temperature of about 30° C., about 40° C., about 50° C., about 60° C., about 70° C., about 80° C., about 90° C., about 100° C., about 150° C., about 200° C., about 250° C., about 300° C., about 350° C., about 400° C., about 450° C., or about 500° C.

In some embodiments, the dry powder remaining after vaporizing the liquid in the oven 140a and can include a mixture of both active material and conductive material. In some embodiments, the dry powder recovered from the oven can include at least about 60 wt%, at least about 65 wt%, at least about 70 wt%, at least about 75 wt%, at least about 80 wt%, at least about 85 wt%, at least about 90 wt%, at least about 95 wt%, at least about 96 wt%, at least about 97 wt%, at least about 98 wt%, at least about 99 wt%, or at least about 99.9 wt% conductive material. In some embodiments, the dry powder remaining after vaporizing the liquid in the oven 140a and can include no more than about 100 wt%, no more than about 99.9 wt%, no more than about 99 wt%, no more than about 98 wt%, no more than about 97 wt%, no more than about 96 wt%, no more than about 95 wt%, no more than about 90 wt%, no more than about 85 wt%, no more than about 80 wt%, no more than about 75 wt%, no more than about 70 wt%, or no more than about 65 wt% conductive material. Combinations of the above-referenced weight percentages are also possible (e.g., at least about 60 wt% and no more than about 99.9 wt% or at least about 70 wt% and no more than about 90 wt%), inclusive of all values and ranges therebetween. In some embodiments, the dry powder recovered from the oven 140a can include about 60 wt%, about 65 wt%, about 70 wt%, about 75 wt%, about 80 wt%, about 85 wt%, about 90 wt%, about 95 wt%, about 96 wt%, about 97 wt%, about 98 wt%, about 99 wt%, about 99.9 wt%, or about 100 wt% conductive material.

The oven 140b vaporizes liquid from the active material/solvent mixture, leaving behind dry powder. In some embodiments, dry active material powder can be reused. In some embodiments, the dry active material powder can be combined with fresh active material and reused. In some embodiments, dry active material powder can be packaged and sold to a third party. In some embodiments, the oven 140b can be heated to a temperature of at least about 30° C., at least about 40° C., at least about 50° C., at least about 60° C., at least about 70° C., at least about 80° C., at least about 90° C., at least about 100° C., at least about 150° C., at least about 200° C., at least about 250° C., at least about 300° C., at least about 350° C., at least about 400° C., or at least about 450° C. In some embodiments, the oven 140b can be heated to a temperature of no more than about 500° C., no more than about 450° C., no more than about 400° C., no more than about 350° C., no more than about 300° C., no more than about 250° C., no more than about 200° C., no more than about 150° C., no more than about 100° C., no more than about 90° C., no more than about 80° C., no more than about 70° C., no more than about 60° C., no more than about 50° C., or no more than about 40° C.

Combinations of the above-referenced temperatures are also possible (e.g., at least about 30° C. and no more than 500° C. or at least about 100° C. and no more than about 300° C.), inclusive of all values and ranges therebetween. In some embodiments, the oven 140b can be heated to a temperature of about 30° C., about 40° C., about 50° C., about 60° C., about 70° C., about 80° C., about 90° C., about 100° C., about 150° C., about 200° C., about 250° C., about 300° C., about 350° C., about 400° C., about 450° C., or about 500° C.

In some embodiments, the dry powder remaining after vaporizing the liquid in the oven 140b and can include a mixture of both active material and conductive material. In some embodiments, the dry powder recovered from the oven can include at least about 60 wt%, at least about 65 wt%, at least about 70 wt%, at least about 75 wt%, at least about 80 wt%, at least about 85 wt%, at least about 90 wt%, at least about 95 wt%, at least about 96 wt%, at least about 97 wt%, at least about 98 wt%, at least about 99 wt%, or at least about 99.9 wt% active material. In some embodiments, the dry powder remaining after vaporizing the liquid in the oven 140b and can include no more than about 100 wt%, no more than about 99.9 wt%, no more than about 99 wt%, no more than about 98 wt%, no more than about 97 wt%, no more than about 96 wt%, no more than about 95 wt%, no more than about 90 wt%, no more than about 85 wt%, no more than about 80 wt%, no more than about 75 wt%, no more than about 70 wt%, or no more than about 65 wt% active material. Combinations of the above-referenced weight percentages are also possible (e.g., at least about 60 wt% and no more than about 99.9 wt% or at least about 70 wt% and no more than about 90 wt%), inclusive of all values and ranges therebetween. In some embodiments, the dry powder recovered from the oven 140b can include about 60 wt%, about 65 wt%, about 70 wt%, about 75 wt%, about 80 wt%, about 85 wt%, about 90 wt%, about 95 wt%, about 96 wt%, about 97 wt%, about 98 wt%, about 99 wt%, about 99.9 wt%, or about 100 wt% active material.

In some embodiments, the oven 140a and/or the oven 140b can include a vacuum. In some embodiments, the oven 140a and/or the oven 140b can be operated at a pressure of less than about 1 bar (absolute), less than about 0.95 bar, less than about 0.9 bar, less than about 0.85 bar, less than about 0.8 bar, less than about 0.75 bar, less than about 0.7 bar, less than about 0.65 bar, less than about 0.6 bar, less than about 0.55 bar, less than about 0.5 bar, less than about 0.45 bar, less than about 0.4 bar, less than about 0.35 bar, less than about 0.3 bar, less than about 0.25 bar, less than about 0.2 bar, less than about 0.15 bar, or less than about 0.1 bar, inclusive of all values and ranges therebetween.

In some embodiments, the oven 140a and/or the oven 140b can be filled with air. In some embodiments, the oven 140a and/or the oven 140b can be maintained with an inert atmosphere. In some embodiments, the oven 140a and/or the oven 140b can be filled with an inert gas. In some embodiments, the inert gas can include nitrogen. In some embodiments, the inert gas can include argon. In some embodiments, the oven 140a and/or the oven 140b can include at least about 90 vol%, at least about 91 vol%, at least about 92 vol%, at least about 93 vol%, at least about 94 vol%, at least about 95 vol%, at least about 97 vol%, at least about 98 vol%, at least about 99 vol%, at least about 99.9 vol%, at least about 99.99 vol%, at least about 99.999 vol%, or at least about 99.9999 vol% inert gas.

The solvent bath 150 can be used to separate current collectors from semi-solid electrode material, prior to feeding the semi-solid electrode material to the mixing vessel 110. In some embodiments, the solvent bath 150 can include a sonicator. In some embodiments, the solvent used in the solvent bath 150 can include water. In some embodiments, the solvent bath 150 can include a non-aqueous electrolyte solvent. In some embodiments, the solvent bath 150 can include acetonitrile, acetone, ethanol, isopropyl alcohol, or any combination thereof. In some embodiments, the solvent bath 150 can include VC, PS, EP, PSA/TS, FEC, ES, TOP, DTD, EA, MA, EC, PC, DMC, EMC, or combinations thereof. In some embodiments, the solvent bath can include a salt dissolved therein. In some embodiments, the salt can include LiBOB, LiPF₆, LiFSI, or any combination thereof.

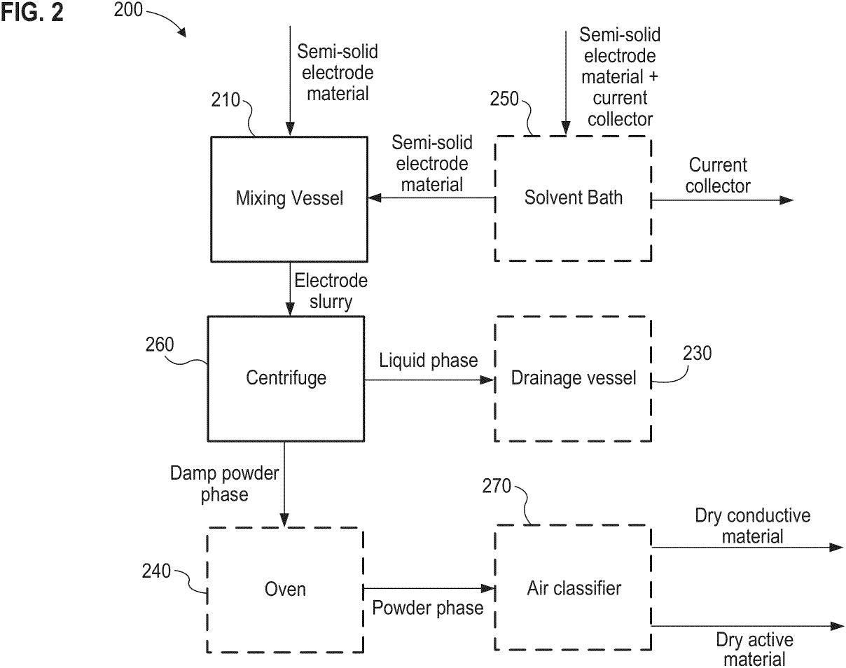

FIG. 2 is a block diagram of a system 200 for recycling electrode materials, according to an embodiment. As shown, the system 200 includes a mixing vessel 210, and a centrifuge 260. The system 200 optionally includes a drainage vessel 230, an oven 240, a solvent bath 250, and an air classifier 270. In some embodiments, the mixing vessel 210, the drainage vessel 230, the oven 240, and the solvent bath 250, can be the same or substantially similar to the mixing vessel 110, the drainage vessel 130, the ovens 140, and the solvent bath 150, as described above with reference to FIG. 1. Thus, certain aspects of the mixing vessel 210, the drainage vessel 230, the oven 240, and the solvent bath 250 are not described in greater detail herein.

In use, a first amount of semi-solid electrode material is fed to the mixing vessel 210. Optionally, a second amount of semi-solid electrode material coupled to a current collector can be fed to the solvent bath 250, and the second amount of semi-solid electrode material can be separated from the current collector and fed to the mixing vessel 210. In the mixing vessel 210, the first amount of semi-solid electrode material (and optionally the second amount of semi-solid electrode material are mixed with a solvent to form an electrode slurry. The electrode slurry is fed to the centrifuge 260, where the electrode slurry is separated into a liquid phase and a damp powder phase (e.g., via the drainage vessel 230). The damp powder phase is fed to the oven 240, where heat is applied to evaporate liquid, separating the liquid from the powder phase. The powder phase is fed to the air classifier 270, where dry active material and dry conductive material are separated based on the size, shape, and/or density of their particles. In embodiments that do not include the air classifier 270, a product that includes a dry conductive material and a dry active material can be recovered from the oven 240. In some embodiments, the product can include active and conductive material in a wt:wt ratio of about 1:99, about 5:95, about 10:90, about 15:85, about 20:80, about 25:75, about 30:70, about 35:65, about 40:60, about 45:55, about 50:50, about 55:45, about 60:40, about 65:35, about 70:30, about 75:25, about 80:20, about 85:15, about 90:10, about 95:5, or about 99:1, inclusive of all values and ranges therebetween.

The centrifuge 260 separates the electrode slurry into a solid phase (i.e., a cake) and a liquid phase. The solid phase includes active material and conductive material, with a small amount of electrolyte solution therein. The liquid phase can include a dilute electrolyte solvent. In some embodiments, the centrifuge 260 can be operated as a batch unit. In other words, the electrode slurry can be fed into the centrifuge 260 and the solid phase and liquid phase can be actively retrieved from the centrifuge 260. In some embodiments, the centrifuge 260 can be operated as a continuous unit. In other words, the electrode slurry can be fed into the centrifuge 260 and the solid phase and liquid phase can be advanced further via a series of pumps, pipes, or other process equipment. In some embodiments, the drainage vessel 230 can capture the liquid phase separated via the centrifuge 260. In some embodiments, the centrifuge 260 can include a filter disposed therein.

In the optional air classifier 270, active material is separated from conductive material based on the size, shape, and/or density of their particles. Air or another inert gas can be fed through the bottom of the air classifier 270, while the active material/conductive material mix is fed through the top of the air classifier 270. Larger active particles can drop to the bottom of the air classifier 270 while smaller conductive particles rise to the top. Both active and conductive particles can be collected in collection vessels. In some embodiments, the system 200 can include a cyclone separator (not shown) instead of or in addition to the air classifier 270 for separating active material from conductive material.

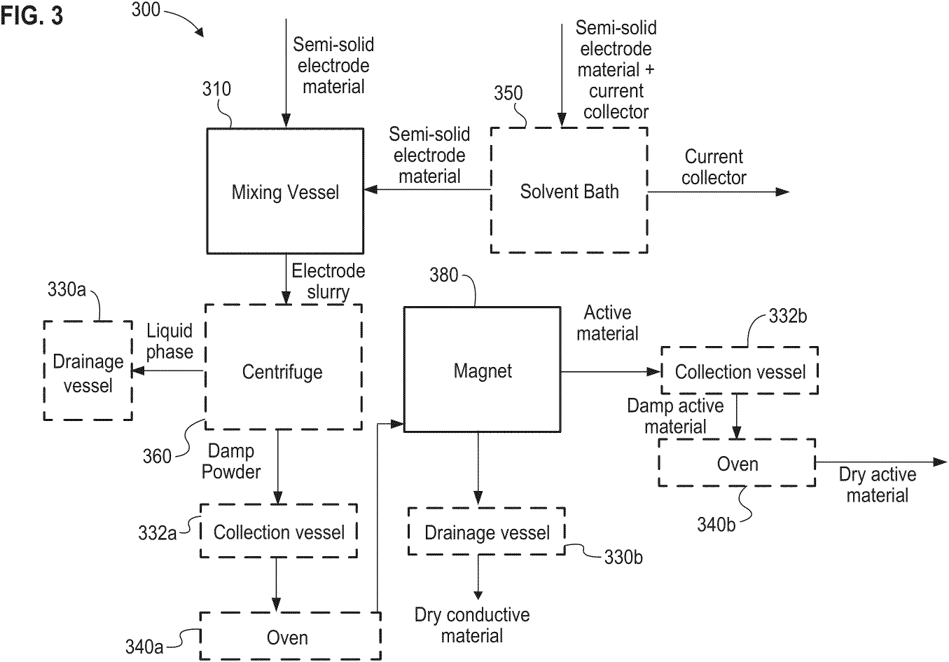

FIG. 3 is a block diagram of a system 300 for recycling electrode materials, according to an embodiment. As shown, the system 300 includes a mixing vessel 310, and a magnet 380. In some embodiments, the system 300 can include drainage vessels 330a, 330b (collectively referred to as drainage vessels 330), collection vessels 332a, 332b (collectively referred to as collection vessels 332), ovens 340a, 340b (collectively referred to as ovens 340), a solvent bath 350, and a centrifuge 360. In some embodiments, the mixing vessel 310, the drainage vessels 330, the ovens 340, the solvent bath 350, and the centrifuge 360, can be the same or substantially similar to the mixing vessel 210, the drainage vessel 230, the oven 240, the solvent bath 250, and the centrifuge 260, as described above with reference to FIG. 2. Thus, certain aspects of the mixing vessel, the drainage vessels 330, the ovens 340, the solvent bath 350, and the centrifuge 360 are not described in greater detail herein.

In use, a first amount of semi-solid electrode material is fed to the mixing vessel 310. Optionally, a second amount of semi-solid electrode material coupled to a current collector can be fed to the solvent bath 350, and the second amount of semi-solid electrode material can be separated from the current collector and fed to the mixing vessel 310. In the mixing vessel 310, the first amount of semi-solid electrode material (and optionally the second amount of semi-solid electrode material are mixed with a solvent to form an electrode slurry.

In some embodiments, the electrode slurry is fed to the centrifuge 360, where the electrode slurry is separated into a liquid phase and a damp powder phase (e.g., via the drainage vessel 330a). The damp powder slurry is then collected in the collection vessel 332a and dried via the oven 340a. The oven 340a dries the damp powder, and the resulting dry powder is fed to the magnet 380. In embodiments without the centrifuge 360, the electrode slurry is fed directly from the mixing vessel 310 to the magnet 380.

The magnet 380 can be applied to the electrode slurry or the dry powder either before, during, and/or after the application of the centrifuge 360. The differing magnetic properties of the active material and the conductive material aid in separating the active material and the conductive material. In some embodiments, a liquid phase exits the magnet 380 (or a vessel in which the magnet 380 is housed) via the drainage vessel 380b. As shown, the system 300 includes two drainage vessels 330. In some embodiments, the system can include, 1, 2, 3, 4, 5, 6, 7, 8, 9, 10, or at least about 10 drainage vessels 330. A conductive material slurry is optionally fed to the collection vessel 332a and the oven 340a to produce a dry conductive powder. An active material slurry is optionally fed to the collection vessel 332b and the oven 340b to produce a dry active material.

In some embodiments, the magnet 380 can be incorporated into the centrifuge 360. The electrode slurry can be fed to the centrifuge 360 and the magnet can aid in separating the electrode slurry into an active material slurry and a conductive material slurry. In some embodiments, the two slurries can be separately directed outward via pipes. In some embodiments, each of the slurries can be fed to different drainage vessels 332 and ovens 340.

In some embodiments, the dry conductive material recovered from the magnet 380 can include an amount of dry active material. In some embodiments, the dry conductive material recovered from the magnet 380 can have a purity of about 70 wt%, about 75 wt%, about 80 wt%, about 85 wt%, about 90 wt%, about 95 wt%, about 96 wt%, about 97 wt%, about 98 wt%, about 99 wt%, about 99.5 wt%, about 99.6 wt%, about 99.7 wt%, about 99.8 wt%, or about 99.9 wt%, inclusive of all values and ranges therebetween.

In some embodiments, the dry active material recovered from the magnet 380 and/or the oven 340b can include an amount of dry conductive material. In some embodiments, the dry active material recovered from the magnet 380 and/or the oven 340b can have a purity of about 70 wt%, about 75 wt%, about 80 wt%, about 85 wt%, about 90 wt%, about 95 wt%, about 96 wt%, about 97 wt%, about 98 wt%, about 99 wt%, about 99.5 wt%, about 99.6 wt%, about 99.7 wt%, about 99.8 wt%, or about 99.9 wt%, inclusive of all values and ranges therebetween.

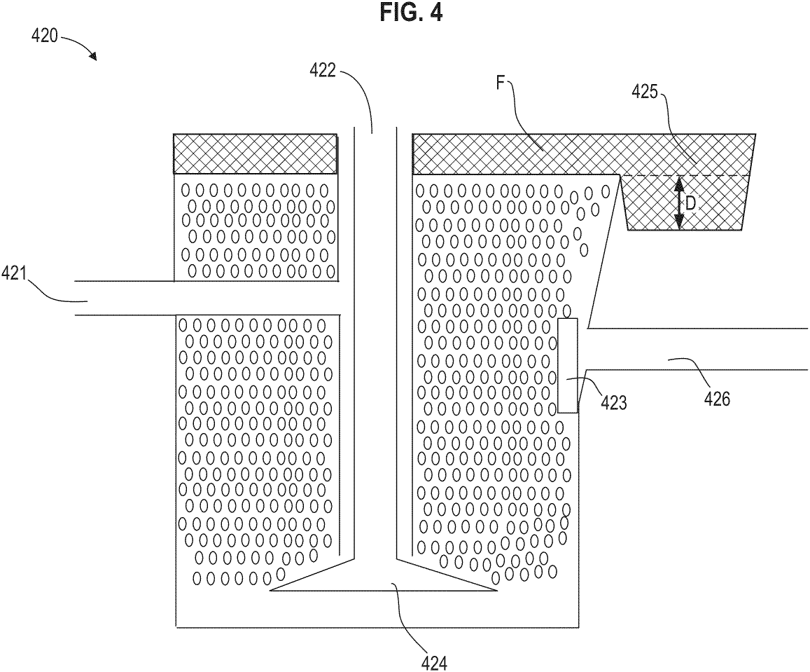

FIG. 4 is an illustration of a froth flotation vessel 420, according to an embodiment. As shown, the froth flotation vessel 420 includes a pulp inlet 421, a gas inlet 422, an exit valve 423, a sparger 424, a froth collection area 425, and an exit path 426. In some embodiments, the froth flotation vessel 420 can be filled with water or an aqueous solution. In some embodiments, the froth flotation vessel 420 can be filled with an electrolyte solvent. In some embodiments, the froth flotation vessel 420 can include VC, PS, EP, PSA/TS, FEC, ES, TOP, DTD, EA, MA, EC, PC, DMC, EMC, or any combination thereof. In some embodiments, the froth flotation vessel 420 can include a salt dissolved therein. In some embodiments, the salt can include LiBOB, LiPF₆, LiFSI, or any combination thereof.

The pulp inlet 421 receives pulp in the froth flotation vessel 420. The pulp inlet 421 is fluidically coupled to the interior of the froth flotation vessel 420. In some embodiments, the pulp can include the electrode slurry. A gas flows into the froth flotation vessel 420 via the gas inlet 422. In some embodiments, the gas can include air, nitrogen, argon, helium, or any other suitable inert gas or combinations thereof. The sparger 424 causes the gas to disperse into the liquid in the froth flotation vessel 420. Bubbles rise to the top of the froth flotation vessel 420 to create a froth F.

Hydrophobic particles (or particles that do not have an affinity for the liquid in the froth flotation vessel 420), such as the conductive material, adhere to the bubbles and collect at the top of the froth flotation vessel 420. In some embodiments, at least about 80 wt%, at least about 81 wt%, at least about 82 wt%, at least about 83 wt%, at least about 84 wt%, at least about 85 wt%, at least about 86 wt%, at least about 87 wt%, at least about 88 wt%, at least about 89 wt%, at least about 90 wt%, at least about 91 wt%, at least about 92 wt%, at least about 93 wt%, at least about 94 wt%, at least about 95 wt%, at least about 96 wt%, at least about 97 wt%, at least about 98 wt%, or at least about 99 wt% of the conductive material can rise to the top of the froth flotation vessel 420 and collect in the froth F. Meanwhile, hydrophilic particles (or particles that do have an affinity for the liquid in the froth flotation vessel 420), such as the active material, become suspended and/or dissolved in the liquid. The active particles and the solvent exit the froth flotation tank 420 via the exit path 426. The exit valve 423 can be positioned and oriented such that bubbles (and the conductive particles appended thereto) are prevented from exiting. Since the bubbles rise upward and move laterally, the exit valve 423 covers the exit path such that fluid moves downward to circumvent the exit valve 423 and exit via the exit path 426.

Near the top of the froth flotation vessel 420, the froth collection area 425 provides a space where the bubbles can rupture, leaving behind the conductive particles and solvent. In some embodiments, the froth collection area 425 can include a depression, where the conductive particles and solvent can collect after passing over a ridge near the top of the froth flotation vessel 420. As shown, the collection area 425 has a depth D, which is the distance the collection area 425 extends downward after the ridge near the top of the froth flotation vessel 420. In some embodiments, the depth D can be about 1 cm, about 2 cm, about 3 cm, about 4 cm, about 5 cm, about 6 cm, about 7 cm, about 8 cm, about 9 cm, about 10 cm, about 20 cm, about 30 cm, about 40 cm, about 50 cm, about 60 cm, about 70 cm, about 80 cm, about 90 cm, or about 1 m, inclusive of all values and ranges therebetween.

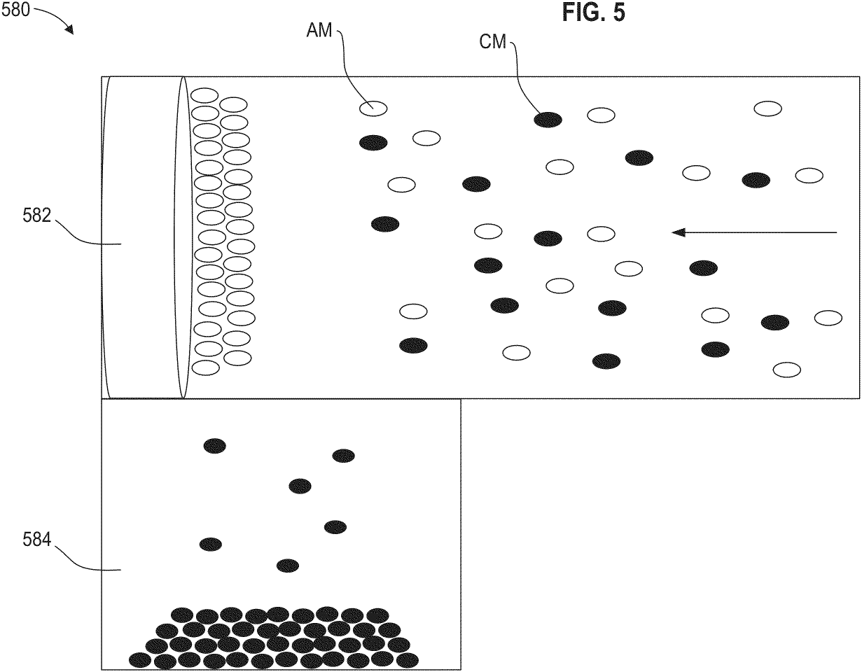

FIG. 5 is an illustration of a magnet 580, according to an embodiment. As shown, the magnet 580 includes a magnetic surface 582 and a collection area 584. Particles of active material AM are attracted to the magnet while particles of the conductive material CM settle in the collection area. In some embodiments, the active material AM can be scraped off the magnetic surface 582 and separated from the particles of conductive material CM. In some embodiments, the conductive material CM can be sent away from the magnet 580 via a series of pipes and pumps. In some embodiments, the magnetic surface 582 can be composed of a ferromagnetic material. In some embodiments, the magnetic surface 582 can be composed of a paramagnetic material. In some embodiments, the magnetic surface 582 can be composed of a diamagnetic material. In some embodiments, the magnetic surface 582 can include a neodymium magnet (NdFeB).

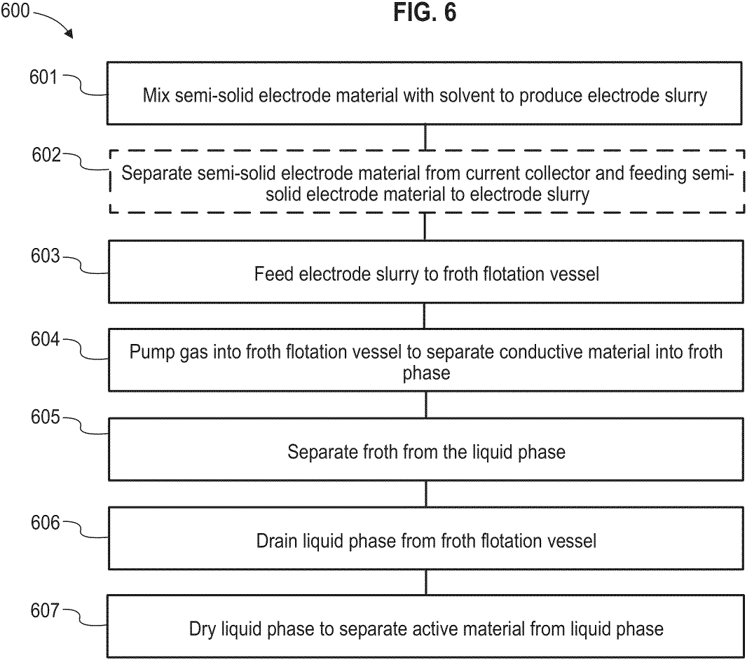

FIG. 6 is a block diagram of a method 600 of recycling electrode materials, according to an embodiment. As shown, the method 600 includes mixing a semi-solid electrode material with a solvent to produce an electrode slurry at step 601. The semi-solid electrode material includes an active material, a conductive material, and an electrolyte solution. The method 600 optionally includes separating a semi-solid electrode material from a current collector and feeding the semi-solid electrode material to the electrode slurry at step 602. The method 600 further includes feeding the electrode slurry to a froth flotation vessel at step 603, pumping gas into the froth flotation vessel to separate the conductive material into a froth phase at step 604, separating the froth from the liquid phase at step 605, draining the liquid phase from the froth flotation vessel at step 606, and drying the liquid phase to separate the active material from the liquid phase at step 607.

Step 601 includes mixing a semi-solid electrode material with a solvent to produce an electrode slurry. The semi-solid electrode material includes an active material, a conductive material, and an electrolyte solution. In some embodiments, the solvent can include water or an aqueous solution. In some embodiments, the solvent can include an electrolyte solvent. In some embodiments, the solvent can include EC, DEC, DMC, EMC, or combinations thereof. In some embodiments, the mixing can be in a mixing vessel (e.g., the mixing vessel 110, as described above with reference to FIG. 1). In some embodiments, the semi-solid electrode material can be collected from a disassembled pouch cell, a disassembled unit cell, an electrode, a process slurry, and/or a used electrochemical cell. In some embodiments, the slurry can be washed. In some embodiments, the slurry washing can be via subcritical fluid (e.g., subcritical CO₂).

In some embodiments, the semi-solid electrode material can be crushed and/or grinded prior to mixing the semi-solid electrode material with the solvent. In some embodiments, the semi-solid electrode material can be crushed and/or grinded while mixing the semi-solid electrode material with the solvent. In some embodiments, the electrode slurry can be subject to grinding and/or crushing. In some embodiments, the semi-solid electrode material can be subjected to screening prior to mixing the semi-solid electrode material with the solvent. In some embodiments, the semi-solid electrode material can be subjected to screening while mixing the semi-solid electrode material with the solvent. The screening can separate larger particles from the semi-solid electrode. In some embodiments, the electrode slurry can be subject to screening. In some embodiments, the screening can include employing a vibratory screen.

In some embodiments, the semi-solid electrode material can include an anode material. In some embodiments, the anode material can include a tin metal alloy such as, for example, a Sn— Co—C, a Sn—Fe—C, a Sn—Mg—C, or a La—Ni—Sn alloy. In some embodiments, the anode material can include an amorphous oxide such as, for example, SnO or SiO amorphous oxide. In some embodiments, the anode material can include a glassy anode such as, for example, a Sn— Si—Al—B—O, a Sn—Sb—S—O, a SnO₂—P₂O₅, or a SnO—B₂O₃₋₂O₅₋Al₂O₃ anode. In some embodiments, the anode material can include carbon black. In some embodiments, the anode material can include a metal oxide such as, for example, a CoO, a SnO₂, or a V₂O₅. In some embodiments, the anode material can include a metal nitride such as, for example, Li₃N or Li₂.6CoO.4N. In some embodiments, the anode material can include an anode active material selected from lithium metal, carbon, lithium-intercalated carbon, lithium nitrides, lithium alloys and lithium alloy forming compounds of silicon, bismuth, boron, gallium, indium, zinc, tin, antimony, aluminum, titanium oxide, molybdenum, germanium, manganese, niobium, vanadium, tantalum, gold, platinum, iron, copper, chromium, nickel, cobalt, zirconium, yttrium, molybdenum oxide, germanium oxide, silicon oxide, silicon carbide, any other high capacity materials or alloys thereof, and any other combination thereof. In some embodiments, the anode active material can include silicon and/or alloys thereof. In some embodiments, anode active material can include tin and/or alloys thereof.

In some embodiments, the semi-solid electrode material can include a cathode material. In some embodiments, the cathode material can include the general family of ordered rocksalt compounds LiMO₂ including those having the α-NaFeO₂ (so-called “layered compounds”) or orthorhombic-LiMnO₂ structure type or their derivatives of different crystal symmetry, atomic ordering, or partial substitution for the metals or oxygen. M comprises at least one first-row transition metal but may include non-transition metals including but not limited to Al, Ca, Mg, or Zr. Examples of such compounds include LiFePO₄ (LFP), LiCoO₂, LiCoO₂ doped with Mg, LiNiO₂, Li(Ni, Co, Al)O₂ (known as “NCA”) and Li(Ni, Mn, Co)O₂ (known as “NMC”). In some embodiments, the cathode material can include a spinel structure, such as LiMn₂O₄ and its derivatives, so-called “layered-spinel nanocomposites” in which the structure includes nanoscopic regions having ordered rocksalt and spinel ordering, olivines LiMPO₄ and their derivatives, in which M comprises one or more of Mn, Fe, Co, or Ni, partially fluorinated compounds such as LiVPO₄F, other “polyanion” compounds as described below, and vanadium oxides VₓO_{y} including V₂O₅ and V₆O₁₁. In some embodiments, the cathode material can include a transition metal polyanion compound. In some embodiments, the cathode material can include an alkali metal transition metal oxide or phosphate, and for example, the compound has a composition Aₓ(M′₁-ₐM″ₐ)_{y}(XD₄)_{z}, Aₓ(M′₁-ₐM″ₐ)_{y}(DXD₄)_{z}, or Aₓ(M′₁-ₐM″ₐ)y(X₂D₇)_{z}, and have values such that x, plus y(1-a) times a formal valence or valences of M′, plus y(a) times a formal valence or valence of M″, is equal to z times a formal valence of the XD₄, X₂D₇, or DXD₄ group; or a compound comprising a composition (A₁₋ₐM′ₐ)ₓM′_{y}(XD₄)_{z}, (A₁₋ₐM″ₐ)ₓ(M′_{y}(DXD₄)_{z}(A₁₋ₐM″ₐ)ₐM′_{y}(X₂D₇)_{z} and have values such that (1-a)x plus the quantity ax times the formal valence or valences of M″ plus y times the formal valence or valences of M′ is equal to z times the formal valence of the XD₄, X₂D₇ or DXD₄ group. In the compound, A is at least one of an alkali metal and hydrogen, M′ is a first-row transition metal, X is at least one of phosphorus, sulfur, arsenic, molybdenum, and tungsten, M″ any of a Group HA, IIIA, IVA, VA, VIA, VIIA, VIIIA, IB, IIB, IIIB, IVB, VB, and VIB metal, D is at least one of oxygen, nitrogen, carbon, or a halogen. The positive electroactive material can be an olivine structure compound LiMPO₄, where M is one or more of V, Cr, Mn, Fe, Co, and Ni, in which the compound is optionally doped at the Li, M or O-sites. Deficiencies at the Li-site are compensated by the addition of a metal or metalloid, and deficiencies at the O-site are compensated by the addition of a halogen. In some embodiments, the positive active material comprises a thermally stable, transition-metal-doped lithium transition metal phosphate having the olivine structure and having the formula (Li₁₋ₓZₓ)MPO₄, where M is one or more of V, Cr, Mn, Fe, Co, and Ni, and Z is a non-alkali metal dopant such as one or more of Ti, Zr, Nb, Al, or Mg, and x ranges from 0.005 to 0.05.

In some embodiments, the conductive material can include allotropes of carbon including activated carbon, hard carbon, soft carbon, Ketjen, carbon black, graphitic carbon, carbon fibers, carbon microfibers, vapor-grown carbon fibers (VGCF), fullerenic carbons including “buckyballs”, carbon nanotubes (CNTs), multiwall carbon nanotubes (MWNTs), single wall carbon nanotubes (SWNTs), graphene sheets or aggregates of graphene sheets, and materials comprising fullerenic fragments, or any combination thereof. In some embodiments, the active material, the conductive material, and/or the electrolyte solution can include any of the materials described in U.S. Pat. No. 9,437,864 (“the ‘864 patent”), filed Mar. 10, 2014, titled “Asymmetric Battery Having a Semi-solid Cathode and High Energy Density Anode,” the disclosure of which is hereby incorporated by reference in its entirety.

In some embodiments, the semi-solid electrode material mixed at step 601 can include semi-solid electrode material that has not been incorporated into an electrochemical cell. In other words, the semi-solid electrode material can excess, unused material.

At optional step 602, a semi-solid electrode material is separated from a current collector. In some embodiments, the semi-solid electrode material can be separated from the current collector via mechanical separation. In some embodiments, the semi-solid electrode material can be separated from the current collector via shredding. The semi-solid electrode material mixed at step 601 can be a first amount of semi-solid electrode material and the semi-solid electrode material separated from the current collector at step 602 can be a second amount of semi-solid electrode material. In some embodiments, the second amount of semi-solid electrode material can be from a used electrochemical cell. In some embodiments, the second amount of semi-solid electrode material can be removed from the current collector via a blade. In some embodiments, the second amount of semi-solid electrode material and the current collector can be added to a solvent (e.g., water, alcohol, acetone, EC, DEC, DC, DMC, or any combination thereof) to make the second amount of semi-solid electrode material easier to remove from the current collector. Once the second amount of semi-solid electrode material has been separated from the current collector, the second amount of semi-solid electrode material can be added to the first amount of semi-solid electrode material in forming the electrode slurry.

Step 603 includes feeding the electrode slurry to a froth flotation vessel. In some embodiments, feeding the electrode slurry to the froth flotation vessel can be via one or more pumps or pipes. Step 604 include pumping gas into the froth flotation vessel to separate conductive material into a froth phase. Hydrophobic particles (or particles that do not have an affinity for the solvent used in the froth flotation vessel), such as particles of conductive material, cling to bubbles as the bubbles rise to the top of the froth flotation tank. Hydrophilic particles (or particles that do have an affinity for the solvent used in the froth flotation vessel), such as particles of active material, remain dissolved and/or suspended in the solvent. In some embodiments, the method 600 can include feeding the electrode slurry to a flocculation vessel to separate the active particles from the conductive particles. In some embodiments, at least a portion of the electrode slurry can be used to produce a semi-solid electrode. For example, the electrode slurry can be mixed with active material and conductive material to produce a semi-solid electrode. The semi-solid electrode can be disposed on an additional electrode (or the additional electrode can be placed on the semi-solid electrode) with a separator disposed therebetween to produce an electrochemical cell.

Step 605 includes separating the froth from the liquid phase. In some embodiments, a skimmer and/or a blade can be used to isolate the froth. In some embodiments, the froth can be placed into a separate vessel from the froth flotation vessel. In some embodiments, the froth can be heated to drive off liquids and leave the conductive material in the form of a powder. The resultant powder has a high purity. In some embodiments, the froth separated from the liquid phase can include at least about 80 wt%, at least about 81 wt%, at least about 82 wt%, at least about 83 wt%, at least about 84 wt%, at least about 85 wt%, at least about 86 wt%, at least about 87 wt%, at least about 88 wt%, at least about 89 wt%, at least about 90 wt%, at least about 91 wt%, at least about 92 wt%, at least about 93 wt%, at least about 94 wt%, at least about 95 wt%, at least about 96 wt%, at least about 97 wt%, at least about 98 wt%, or at least about 99 wt% of the conductive material, inclusive of all values and ranges therebetween.

In some embodiments, the method 600 can include drying the froth to isolate the conductive material. The drying of the froth can occur after separating the froth from the liquid phase at step 605. In some embodiments, the drying can be via an oven (e.g., the same or substantially similar to the ovens 140a, 140b described above with reference to FIG. 1). The froth can be isolated from the liquid phase and then dried. In some embodiments, the dry conductive material isolated from drying the froth can have a purity of about 70 wt%, about 75 wt%, about 80 wt%, about 85 wt%, about 90 wt%, about 95 wt%, about 96 wt%, about 97 wt%, about 98 wt%, about 99 wt%, about 99.5 wt%, about 99.6 wt%, about 99.7 wt%, about 99.8 wt%, or about 99.9 wt%, inclusive of all values and ranges therebetween.

Step 606 includes draining a liquid phase (i.e., including the active material) from the froth flotation vessel. In some embodiments, the draining can be via a drain valve. In some embodiments, the liquid phase can be transported away from the froth flotation vessel. Step 607 includes drying the liquid phase to separate the active material from the liquid phase. Step 607 can include isolating the active material. In some embodiments, the drying can be via heating the liquid phase to vaporize the liquid phase and leave the active material. In some embodiments, the drying can be via an oven. In some embodiments, a vacuum can be applied during the drying. In some embodiments, the vacuuming can be to a pressure of less than about 1 bar (absolute), less than about 0.95 bar, less than about 0.9 bar, less than about 0.85 bar, less than about 0.8 bar, less than about 0.75 bar, less than about 0.7 bar, less than about 0.65 bar, less than about 0.6 bar, less than about 0.55 bar, less than about 0.5 bar, less than about 0.45 bar, less than about 0.4 bar, less than about 0.35 bar, less than about 0.3 bar, less than about 0.25 bar, less than about 0.2 bar, less than about 0.15 bar, or less than about 0.1 bar, inclusive of all values and ranges therebetween. In some embodiments, the liquid phase can be removed via freeze-drying.

In some embodiments, the heating can be at a temperature of at least about 30° C., at least about 40° C., at least about 50° C., at least about 60° C., at least about 70° C., at least about 80° C., at least about 90° C., at least about 100° C., at least about 150° C., at least about 200° C., at least about 250° C., at least about 300° C., at least about 350° C., at least about 400° C., or at least about 450° C. In some embodiments, the heating can be at a temperature of no more than about 500° C., no more than about 450° C., no more than about 400° C., no more than about 350° C., no more than about 300° C., no more than about 250° C., no more than about 200° C., no more than about 150° C., no more than about 100° C., no more than about 90° C., no more than about 80° C., no more than about 70° C., no more than about 60° C., no more than about 50° C., or no more than about 40° C.

Combinations of the above-referenced temperatures are also possible (e.g., at least about 30° C. and no more than 500° C. or at least about 100° C. and no more than about 300° C.), inclusive of all values and ranges therebetween. In some embodiments, heating can be at a temperature of about 30° C., about 40° C., about 50° C., about 60° C., about 70° C., about 80° C., about 90° C., about 100° C., about 150° C., about 200° C., about 250° C., about 300° C., about 350° C., about 400° C., about 450° C., or about 500° C.

The captured active material has a high purity. In some embodiments, the captured active material can include at least about 80 wt%, at least about 81 wt%, at least about 82 wt%, at least about 83 wt%, at least about 84 wt%, at least about 85 wt%, at least about 86 wt%, at least about 87 wt%, at least about 88 wt%, at least about 89 wt%, at least about 90 wt%, at least about 91 wt%, at least about 92 wt%, at least about 93 wt%, at least about 94 wt%, at least about 95 wt%, at least about 96 wt%, at least about 97 wt%, at least about 98 wt%, or at least about 99 wt% of the active material, inclusive of all values and ranges therebetween.

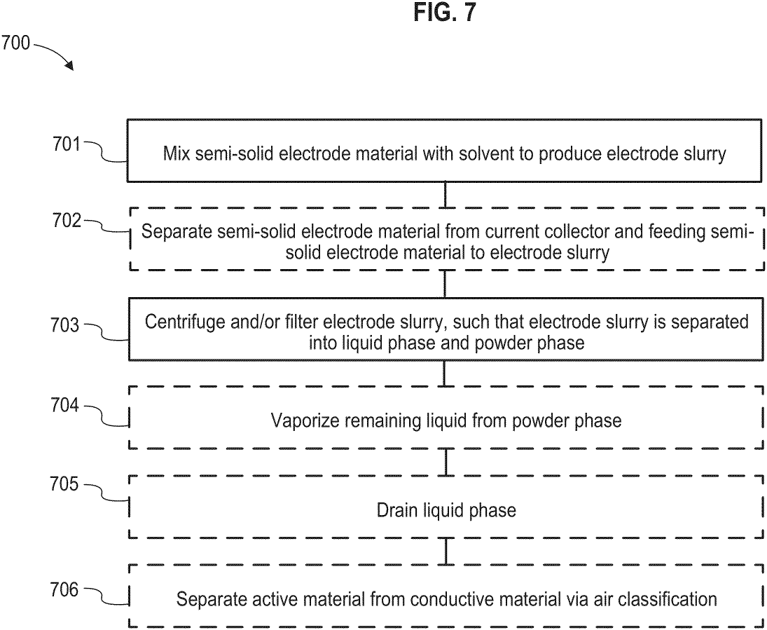

FIG. 7 is a block diagram of a method 700 of recycling electrode materials, according to an embodiment. As shown, the method 700 includes mixing a semi-solid electrode material with a solvent to produce an electrode slurry at step 701. The semi-solid electrolyte material includes an active material, a conductive material, and an electrolyte solution. The method 700 optionally includes separating a semi-solid electrode material from a current collector and feeding the semi-solid electrode material to the electrode slurry at step 702. The method 700 further includes centrifuging and/or filtering the electrode slurry, such that the electrode slurry is separated into a liquid phase and a powder phase at step 703. The method 700 optionally includes vaporizing the remaining liquid from the powder phase at step 704, draining the liquid phase at step 705, and separating the active material from the conductive material via air classification at step 706.

In some embodiments, step 701 and step 702 can be the same or substantially similar to step 601 and step 602, as described above with reference to FIG. 6. Thus, certain aspects of step 701 and step 702 are not described in greater detail herein. Step 703 includes separating the electrode slurry into liquid and solid phases via centrifugation and filtration. The liquid phase includes electrolyte solution and can be dilute. In some embodiments, the liquid phase can have an electrolyte salt concentration of less than about 2 M, less than about 1.9 M, less than about 1.8 M, less than about 1.7 M, less than about 1.6 M, less than about 1.5 M, less than about 1.4 M, less than about 1.3 M, less than about 1.2 M, less than about 1.1 M, less than about 1 M, less than about 0.9 M, less than about 0.8 M, less than about 0.7 M, less than about 0.6 M, less than about 0.5 M, less than about 0.4 M, less than about 0.3 M, less than about 0.2 M, or less than about 0.1 M, inclusive of all values and ranges therebetween.

The solid phase includes active material and conductive material. In some embodiments, the solid phase can include at least about 80 wt%, at least about 81 wt%, at least about 82 wt%, at least about 83 wt%, at least about 84 wt%, at least about 85 wt%, at least about 86 wt%, at least about 87 wt%, at least about 88 wt%, at least about 89 wt%, at least about 90 wt%, at least about 91 wt%, at least about 92 wt%, at least about 93 wt%, at least about 94 wt%, at least about 95 wt%, at least about 96 wt%, at least about 97 wt%, at least about 98 wt%, or at least about 99 wt% solids, inclusive of all values and ranges therebetween.

In some embodiments, the centrifuge spin rate employed at step 703 can be at least about 50 rpm, at least about 100 rpm, at least about 200 rpm, at least about 300 rpm, at least about 400 rpm, at least about 500 rpm, at least about 600 rpm, at least about 700 rpm, at least about 800 rpm, at least about 900 rpm, at least about 1,000 rpm, at least about 2,000 rpm, at least about 3,000 rpm, at least about 4,000 rpm, at least about 5,000 rpm, at least about 6,000 rpm, at least about 7,000 rpm, at least about 8,000 rpm, at least about 9,000 rpm, at least about 10,000 rpm, at least about 20,000 rpm, at least about 30,000 rpm, at least about 40,000 rpm, at least about 50,000 rpm, at least about 60,000 rpm, at least about 70,000 rpm, at least about 80,000 rpm, or at least about 90,000 rpm. In some embodiments, the centrifuge spin rate employed at step 703 can be no more than about 100,000 rpm, no more than about 90,000 rpm, no more than about 80,000 rpm, no more than about 70,000 rpm, no more than about 60,000 rpm, no more than about 50,000 rpm, no more than about 40,000 rpm, no more than about 30,000 rpm, no more than about 20,000 rpm, no more than about 10,000 rpm, no more than about 9,000 rpm, no more than about 8,000 rpm, no more than about 7,000 rpm, no more than about 6,000 rpm, no more than about 5,000 rpm, no more than about 4,000 rpm, no more than about 3,000 rpm, no more than about 2,000 rpm, no more than about 1,000 rpm, no more than about 900 rpm, no more than about 800 rpm, no more than about 700 rpm, no more than about 600 rpm, no more than about 500 rpm, no more than about 400 rpm, no more than about 300 rpm, or no more than about 200 rpm. Combinations of the above-referenced spin rates are also possible (e.g., at least about 100 rpm and no more than about 100,000 rpm or at least about 1,000 rpm and no more than about 10,000 rpm), inclusive of all values and ranges therebetween. In some embodiments, the centrifuge spin rate employed at step 703 can be about 50 rpm, about 100 rpm, about 200 rpm, about 300 rpm, about 400 rpm, about 500 rpm, about 600 rpm, about 700 rpm, about 800 rpm, about 900 rpm, about 1,000 rpm, about 2,000 rpm, about 3,000 rpm, about 4,000 rpm, about 5,000 rpm, about 6,000 rpm, about 7,000 rpm, about 8,000 rpm, about 9,000 rpm, about 10,000 rpm, about 20,000 rpm, about 30,000 rpm, about 40,000 rpm, about 50,000 rpm, about 60,000 rpm, about 70,000 rpm, about 80,000 rpm, about 90,000 rpm, or about 100,000 rpm.

Step 704 is optional and includes vaporizing the remaining liquid from the powder phase to vaporize remaining liquid. In some embodiments, the remaining liquid can be vaporized by heating the powder phase (e.g., via an oven or a furnace). In some embodiments, the powder can be freeze-dried to remove the liquid. In some embodiments, the liquid can be removed via subcritical or supercritical fluid extraction.

Step 705 is optional and includes draining the liquid phase that was captured in step 703. In some embodiments, the liquid phase can be recycled. In some embodiments, the liquid phase can be sold to a third party. In some embodiments, the liquid phase can undergo further processing. In some embodiments, the liquid phase can be removed via freeze-drying. In some embodiments, the liquid phase can be removed via drying, subcritical carbon dioxide extraction, supercritical carbon dioxide extraction, and/or solvent mass extraction (e.g., with non-aqueous or aqueous solvents).

Step 706 is optional and includes separating the powder phase into an active material and a conductive material via air classification. In the air classifier, active material is separated from conductive material based on the size, shape, and/or density of their particles. Air or another inert gas can be fed through the bottom of the air classifier, while the active material/conductive material mix is fed through the top of the air classifier. Larger active particles can drop to the bottom of the air classifier while smaller conductive particles rise to the top. Both active and conductive particles can be collected in collection vessels. In some embodiments, the inert gas can include nitrogen, argon, helium, or any other suitable inert gas or combinations thereof. Once separated, the active material and the conductive material can be reused and/or sold to a third party. In some embodiments, step 706 can include cyclone separation.

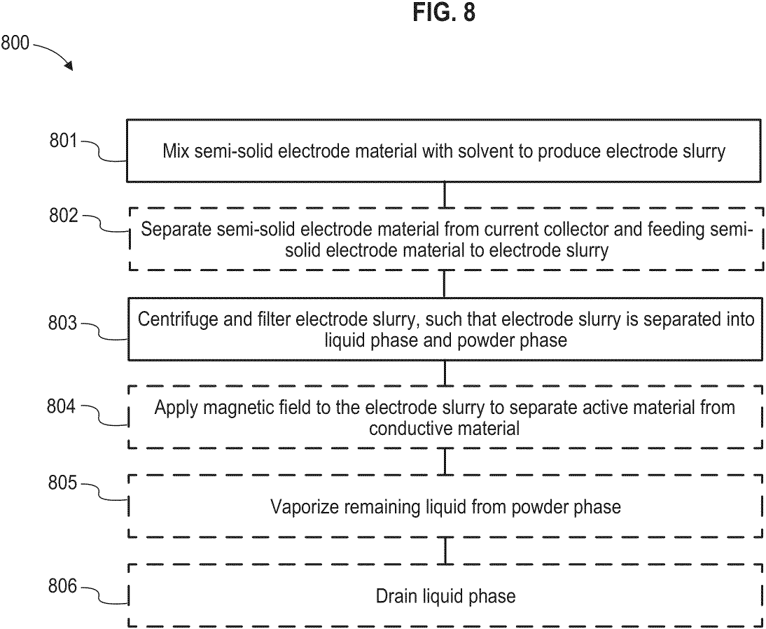

FIG. 8 is a block diagram of a method 800 of recycling electrode materials, according to an embodiment. As shown, the method 800 includes mixing a semi-solid electrode material with a solvent to produce an electrode slurry at step 801. The semi-solid electrolyte material includes an active material, a conductive material, and an electrolyte solution. The method 800 optionally includes separating a semi-solid electrode material from a current collector and feeding the semi-solid electrode material to the electrode slurry at step 802. The method 800 further includes centrifuging and filtering the electrode slurry, such that the electrode slurry is separated into a liquid phase and a powder phase at step 803. The method 800 optionally includes applying a magnetic field to the electrode slurry to separate the active material from the conductive material at step 804, vaporizing the remaining liquid from the powder phase at step 805, and draining the liquid phase at step 806.

In some embodiments, step 801, step 802, and step 803 can be the same or substantially similar to step 701, step 702, and step 703, as described above with reference to FIG. 7. Thus, certain aspects of step 801, step 802, and step 803 are not described in greater detail herein. Step 804 includes applying a magnetic field to the electrode slurry to separate the active material from the conductive material. The magnetic field takes advantage of differences in magnetic properties between the active material and the conductive material. The magnetic field can be particularly advantageous in LFP cell chemistry, given the magnetic properties of LFP.

Step 805 is optional and includes vaporizing remaining liquid from the powder phase. This can be done to both the active material powder and the conductive material powder separated in steps 803 and 804. In some embodiments, step 805 can employ any of the techniques described above in step 704, with reference to FIG. 7. Thus, certain aspects of step 805 are not described in greater detail herein. Step 806 includes draining the liquid phase. In some embodiments, step 806 can employ any of the techniques described above in step 705, with reference to FIG. 7. Thus, certain aspects of step 806 are not described in greater detail herein. In some embodiments, the liquid phase can be removed via freeze-dying.

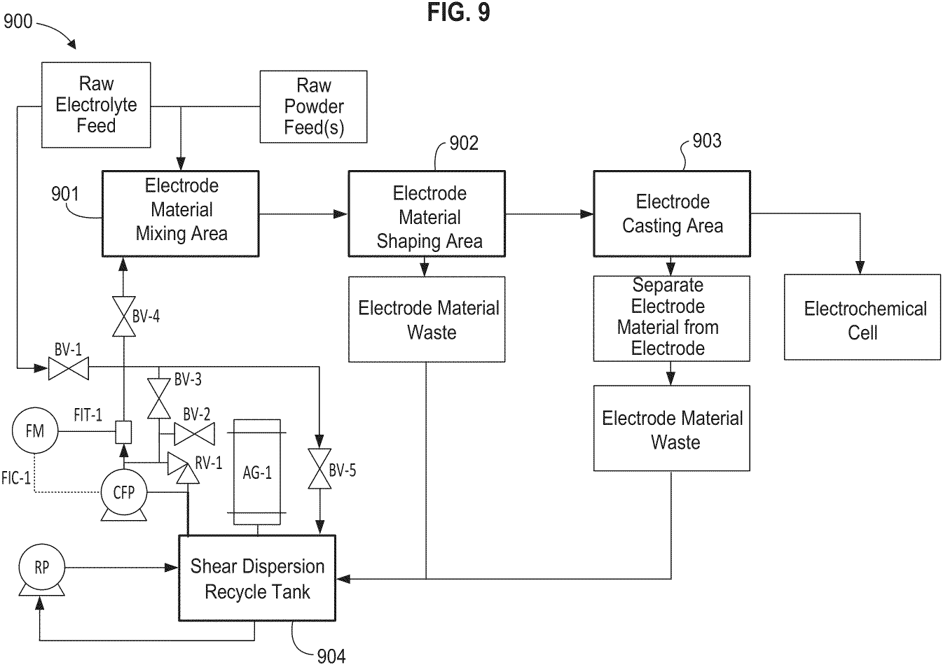

FIG. 9 is a block diagram of a system 900 for recycling electrode materials, according to an embodiment. As shown, the system 900 includes an electrode material mixing area 901, an electrode material shaping area 902, an electrode casting area 903, and a shear dispersion recycle tank 904. In some embodiments, the electrode material mixing area 901, the electrode material shaping area 902, and/or the electrode casting area 903 can include tanks, vessels, and/or any of the process units described above in the systems 100, 200, 300, with reference to FIG. 1, FIG. 2, and FIG. 3. As shown, the shear dispersion recycle tank 904 is coupled to a recirculating pump RP, a constant flow pump CFP, a mixer motor AG-1, a flow indicator transmitter FIT-1, a flow meter FM, flow indicator and controller FIC-1, block valves BV-1, BV-2, BV-3, BV-4, BV-5, and recirculating valve RV-1.

In use, raw electrolyte feed and one or more raw powder feed(s) are fed to the electrode material mixing area 901. A slurry can be formed at the electrode material mixing area 901. After mixing together, the raw electrolyte feed and the raw powder feed(s) become a slurry and are fed to the electrode material shaping area 902. In some embodiments, the raw powder feed can include active and/or conductive material. In some embodiments, the electrode material mixing area 901 is the same area as the electrode material shaping area 902, or the two areas are co-located. From the electrode material shaping area 902, slurry is used to form semi-solid electrodes at the electrode casting area 903. In some embodiments, the electrode casting area 903 can be the same area as the electrode material mixing area 901 and/or the electrode material shaping area 902, or either of the areas can be co-located. Excess electrode material exits the electrode material shaping area as electrode material waste (e.g., slurry waste) and is fed to the shear dispersion recycle tank 904. At the electrode casting area 903, a portion of the slurry contributes to the formation of an electrode and is used in forming an electrochemical cell. Another portion of the slurry is separated from the electrode as electrode material waste and is fed to the shear dispersion recycle tank 904.

The recirculating pump RP circulates electrode material from and back to the shear dispersion recycle tank 904. This recirculating can aid in preventing the electrode material from drying or coagulating. The constant flow pump CFP facilitates a portion of the slurry back to the electrode material mixing area 901 via the block valve BV-4. A portion of the electrolyte is fed to the shear dispersion recycle tank 904 via the block valve BV-1 and the block valve BV-5. A portion of the electrolyte can be re-routed to the block valve BV-3 and sampled at the block valve BV-2. A portion of the re-routed electrolyte can be fed back to the shear dispersion recycle tank via recirculating valve RV-1. The flow indicator transmitter FIT-1, the flow meter FM, and the flow indicator and controller FIC-1 can measure and control the flow of electrolyte into the shear dispersion recycle tank 904 and/or the flow of recycled slurry out of the shear dispersion recycle tank 904.

In some embodiments, about 0.1 wt%, about 0.5 wt%, about 1 wt%, about 1.5 wt%, about 2 wt%, about 2.5 wt%, about 3 wt%, about 3.5 wt%, about 4 wt%, about 4.5 wt%, about 5 wt%, about 5.5 wt%, about 6 wt%, about 6.5 wt%, about 7 wt%, about 7.5 wt%, about 8 wt%, about 8.5 wt%, about 9 wt%, about 9.5 wt%, about 10 wt%, about 20 wt%, about 30 wt%, about 40 wt%, about 50 wt%, about 60 wt%, about 70 wt%, about 80 wt%, about 90 wt%, about 95 wt%, about 99 wt%, or about 99.9 wt%, of the slurry formed in the electrode material shaping area 902 can be recycled to the shear dispersion recycle tank 904, inclusive of all values and ranges therebetween. In some embodiments, about 0.1 wt%, about 0.5 wt%, about 1 wt%, about 1.5 wt%, about 2 wt%, about 2.5 wt%, about 3 wt%, about 3.5 wt%, about 4 wt%, about 4.5 wt%, about 5 wt%, about 5.5 wt%, about 6 wt%, about 6.5 wt%, about 7 wt%, about 7.5 wt%, about 8 wt%, about 8.5 wt%, about 9 wt%, about 9.5 wt%, about 10 wt%, about 10.5 wt%, about 11 wt%, about 11.5 wt%, about 12 wt%, about 12.5 wt%, about 13 wt%, about 13.5 wt%, about 14 wt%, about 14.5 wt%, about 15 wt%, about 20 wt%, about 30 wt%, about 40 wt%, about 50 wt%, about 60 wt%, about 70 wt%, about 80 wt%, about 90 wt%, about 95 wt%, about 99 wt%, or about 99.9 wt% of the material used to form electrodes in the electrode casting area 903 can be recycled to the shear dispersion recycle tank 904, inclusive of all values and ranges therebetween.

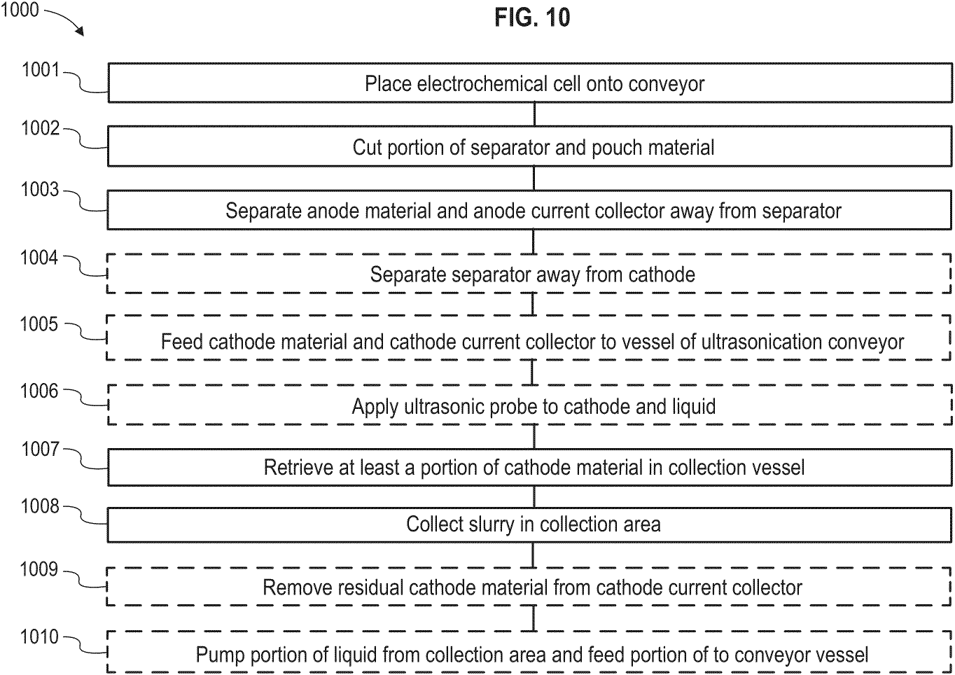

FIG. 10 is a block diagram of a method 1000 of recycling electrode materials, according to an embodiment. As shown, the method 1000 includes placing an electrochemical cell onto a conveyor at step 1001, cutting a portion of a separator and pouch material from the electrochemical cell at step 1002, separating an anode and anode current collector away from the separator at step 1003, optionally separating the separator away from a cathode material and a cathode current collector at step 1004, optionally feeding the cathode material and the cathode current collector to a vessel of an ultrasonication conveyor at step 1005, optionally applying an ultrasonic probe to the cathode material, the cathode current collector, and a liquid at step 1006, retrieving at least a portion of the cathode material in a collection vessel at step 1007, and collecting a slurry in a collection area at step 1008. The method 1000 optionally includes removing residual cathode material from the cathode current collector at step 1009 and pumping a portion of the liquid from the collection area and feeding a portion of the liquid to the conveyor vessel at step 1010.

At step 1001, the method 1000 includes placing the electrochemical cell onto the conveyor. The electrochemical cell includes an anode current collector, an anode material disposed on the anode current collector, a cathode current collector, a cathode material disposed on the cathode current collector, and a separator disposed between the anode material and the cathode material. The electrochemical cell is disposed in a pouch (also referred to herein as a “cell pouch”), such that the separator contacts the pouch material via a sealing region. In some embodiments, the cell pouch can include a first film of pouch material and a second film of pouch material. Electrochemical cells with separators contacting the pouch material via a sealing region are described in greater detail in U.S. Pat. No. 9,178,200, filed Mar. 15, 2013, and titled “Electrochemical Cells and Methods of Manufacturing the Same,” the disclosure of which is hereby incorporated by reference in its entirety. In some embodiments, the cathode material can be a semi-solid cathode material. In some embodiments, the cathode material can have a slurry composition, such that the cathode material adheres to the cathode current collector. In some embodiments, the anode material can be a semi-solid anode material.

In some embodiments, the electrochemical cell can be placed onto the conveyor manually. In some embodiments, the electrochemical cell can be placed onto the conveyor via a machine. In some embodiments, the electrochemical cell can be placed onto the conveyor via a spent cell delivery system or an end-of-life cell delivery system. In some embodiments, the electrochemical cell can include materials that have not undergone a formation and/or aging process. In some embodiments, the electrochemical cell can be placed onto the conveyor with the anode located above the cathode. In some embodiments, the electrochemical cell can be placed onto the conveyor with the cathode located above the anode. In some embodiments, the electrochemical cell can be placed onto the conveyor with a conventional (solid) electrode located above a semi-solid electrode. In some embodiments, the electrochemical cell can be placed onto the conveyor with a semi-solid electrode above a conventional (solid) electrode.

Step 1002 includes cutting a portion of the separator and the pouch material from the electrochemical cell. The cutting of the separator and the pouch material can include cutting at least a portion of the sealing region from the electrochemical cell. In some embodiments, cutting the separator and the pouch material can include cutting the entire sealing region from the electrochemical cell. By cutting the sealing region from the electrochemical cell, the individual components of the electrochemical cell are no longer bound together, such that they can be more easily separated from one another. In some embodiments, the cutting can be via a laser cutter. In some embodiments, the cutting can be via a blade with a cutting edge. In some embodiments, the cutting can be via a moving blade. In some embodiments, the cutting can be via a stationary blade. In some embodiments, the cutting can be via machine cutting. In some embodiments, the cutting can be by hand (i.e., manual).

For laser cutting, the electrochemical is placed on the conveyor with the cathode side down and conveyed forward. As the unit cell moves forward, it is automatically aligned to a set position. The electrochemical cell continues until reaching a laser cutting surface and stops. The laser cutter cuts all four sides of the electrochemical cell, removing pieces of the separator and the pouch. In a machine cutting process, the electrochemical cell can be placed on the conveyor with the cathode side down and the electrochemical cell is conveyed forward. As the electrochemical cell moves forward, it is automatically aligned to a set position. The electrochemical cell continues moving until reaching the cutting edge, which drops down and punch cuts the separator in a four-sided cut (similar to a die press). In a hand cutting process, the electrochemical cell can be affixed cathode side down to a cutting surface and sliced along the sealing region around the outside edges of the electrochemical cell. Upon cutting the separator and the pouch material, the cut pieces can be discarded. In some embodiments, the cut pieces can be saved for future use.

Step 1003 includes separating the anode and the anode current collector away from the separator. In some embodiments, the separating can be via peeling. In some embodiments, the peeling can be performed via a robotic arm. In some embodiments, the peeling of the anode and the anode current collector can be via a stationary blade that remains in place while the electrochemical cell is conveyed toward the stationary blade, such that contact between the anode and the stationary blade separates the anode from the separator. In some embodiments, a vacuum plate can be used to separate the anode from the separator. In some embodiments, the separator can adhere (e.g., via adhesive) to the cathode to prevent cross-contamination between the anode and the cathode. After separating the anode and the anode current collector away from the separator, the anode and anode current collector can be stored in a collection vessel. In some embodiments, the anode and the anode current collector can be transported to the collection vessel via a robotic arm and/or a separate conveyor.

In some embodiments, the separating at step 1003 can be via wedge separation. For wedge separation, the electrochemical cell can be conveyed onto a wedge that acts like a blade to separate the electrochemical cell into two parts: the anode/separator sheet layer, and the cathode layer. In some embodiments, the top layer can be collected by an operator, a robotic arm, or another conveyor to go to a collection vessel that will contain the anode and the separator. This effectively combines steps 1003 and 1004 into a single step. The bottom portion including the cathode can continue to the sonication conveyor (i.e., step 1005). If the anode and the anode current collector are recovered, they can be recovered or saved, depending on the recycling requirements of the facility. If the anode or the anode current collector are recovered, the anode can be subject to the same or substantially similar processing as the cathode material and cathode current collector (i.e., feeding to ultrasonication conveyor, applying an ultrasonic probe, retrieving a portion of the anode, and collecting a slurry in a collection area).

Step 1004 includes separating the separator away from the cathode material. In some embodiments, the peeling of the separator away from the cathode material can be via a stationary blade that remains in place while the remaining components of the electrochemical cell are conveyed toward the stationary blade, such that contact between the separator and the stationary blade separates the separator from the cathode material. When the cathode material adheres to the cathode current collector, the separator can be removed such that losses from the cathode are minimized, as the cathode material is largely attached to the cathode current collector. After separating the separator away from the cathode material, the separator can be stored in a collection vessel. In some embodiments, the separator can be transported to the collection vessel via a robotic arm and/or a separate conveyor.

Step 1005 is optional and includes feeding the cathode material and the cathode current collector to a vessel of an ultrasonication conveyor. The vessel includes a liquid disposed therein. In some embodiments, the vessel can include a short-walled bin. In some embodiments, the ultrasonication conveyor can have multiple vessels formed from sidewalls and barriers on the conveyor. The barriers can move with the conveyor, such that contents in the vessels fall from the ultrasonication conveyor when the barriers reach the bottom of the ultrasonication conveyor and move past parallel with the ground. The liquid disposed in the vessels can aid in dissolving portions of the cathode material and facilitating separation of the cathode material from the cathode current collector. In some embodiments, the liquid can include isopropyl alcohol (IPA). In some embodiments, the liquid can include an organic solvent. In some embodiments, the liquid can include methanol, ethanol, acetone, or any combination thereof.

Step 1006 is optional and includes applying an ultrasonic probe to the cathode and the liquid. In some embodiments, the ultrasonication probe can include a bar horn probe. In some embodiments, the bar horn probe can have a width the same or substantially similar to a width of the cathode. The ultrasonic probe applies an ultrasonic frequency to the cathode and the cathode current collector to facilitate separation of the cathode material from the cathode current collector. In some embodiments, the ultrasonic probe can be activated when the cathode is detected via a visual sensing device (e.g., via an optic sensor). In some embodiments, the visual sensing device can be incorporated into the ultrasonic probe. In some embodiments, multiple ultrasonic probes can be located adjacent to the ultrasonication conveyor, such that the cathode passes through multiple ultrasonic pulses. In some embodiments, the ultrasonic probe can include an ultrasonic welding horn.

In some embodiments, the cathode material can be separated from the cathode current collector via heating. Heat can be applied to the cathode material and the cathode current collector to remove solvents in the cathode material with low boiling points. The cathode material can then be mechanically removed from the cathode current collector. This can include conveying the cathode material and the cathode current collector through an oven warm enough to remove at least a portion of the solvents from the cathode material without damaging any film (e.g., PTFE pouch material coupled to the cathode current collector). The cathode material is then separated from the cathode current collector via mechanical separation.

Upon reaching the end of the ultrasonication conveyor, at least a portion of the cathode material and/or the cathode current collector is retrieved in a collection vessel at step 1007. In some embodiments, the retrieval of the cathode material and/or the cathode current collector can be via a robotic arm and/or a separate conveyor. In some embodiments, the retrieval of the cathode material and/or the cathode current collector can be via an operator. Upon removal of the at least a portion of the cathode material and/or the cathode current collector from the vessel in the ultrasonication conveyor, a residual amount of cathode material and/or the cathode current collector remains in the vessel, forming a slurry with the liquid.

Step 1008 includes collecting the slurry in a collection area. The collection area is located under the ultrasonication conveyor, and the slurry falls to the collection area. In the collection area, the slurry settles and divides into a top phase and a bottom phase. The top phase is mostly liquid (i.e., the liquid from the ultrasonication conveyor vessels) and the bottom phase is mostly cathode material. At step 1009, residual cathode material is optionally removed from the cathode current collector. In some embodiments, the removal of the residual cathode material can be via spraying (e.g., via a jet spray nozzle). In some embodiments, the spraying can be via a thin-silt spray nozzle to remove part or all of the residual cathode material from the cathode current collector. In some embodiments, the spraying can be done above the collection area such that the cathode material falls to the collection area.

Step 1010 is optional and includes pumping a portion of liquid (e.g., IPA) from the collection area back to the conveyor vessel. In some embodiments, the liquid can have residual amounts of cathode slurry. After removal of the liquid from the collection area, the remaining slurry in the collection area can be further processed (e.g., drying, separating active material from conductive material).

As described with respect to the method 1000, the electrochemical cell is conveyed with the cathode side down and the anode on top. The top layers (i.e., the anode) are removed first. In some embodiments, the electrochemical cell can be conveyed with the anode side down and the cathode on top. The top layers (i.e., the cathode and cathode current collector) can be removed first in such an arrangement. As described with respect to the method 1000, the cathode material is separated from the cathode current collector (e.g., via sonication and/or heating). In some embodiments, the anode material can be separated from the anode current collector via the processes described with respect to the method 1000.

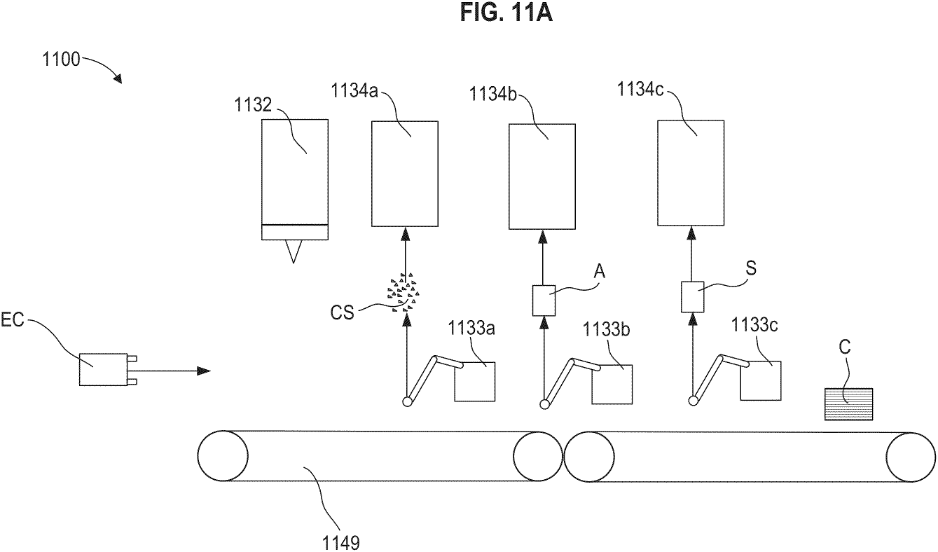

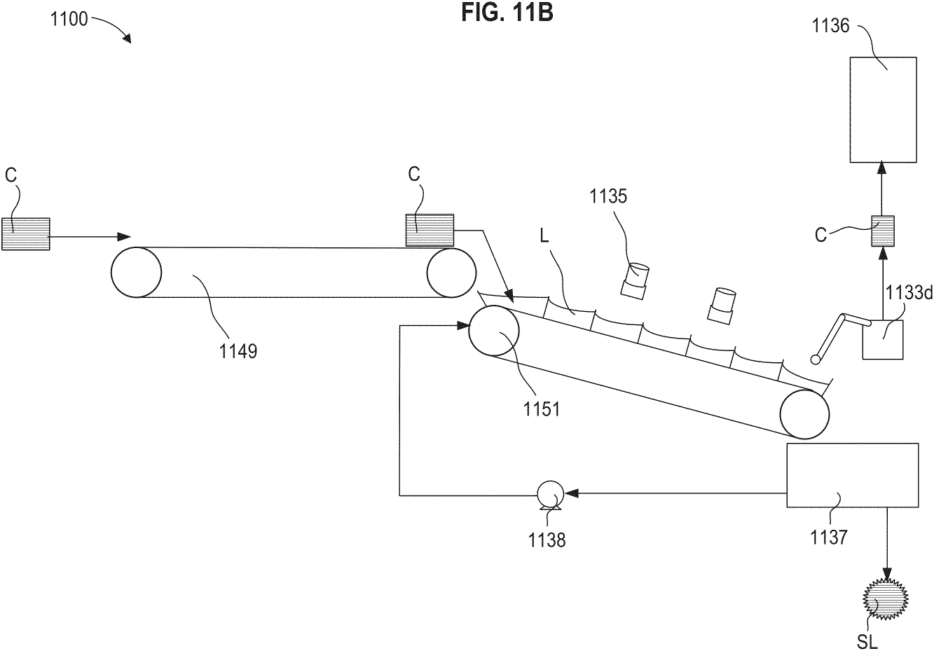

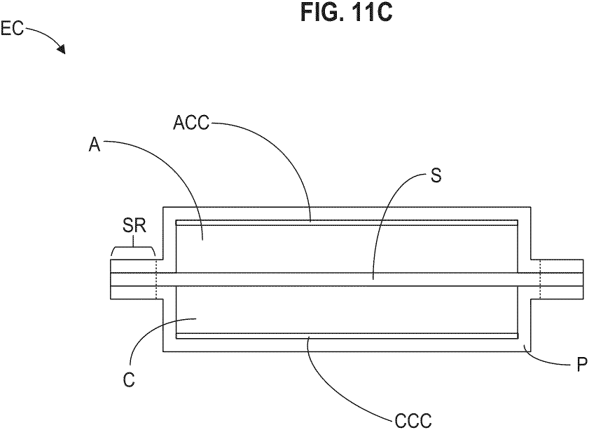

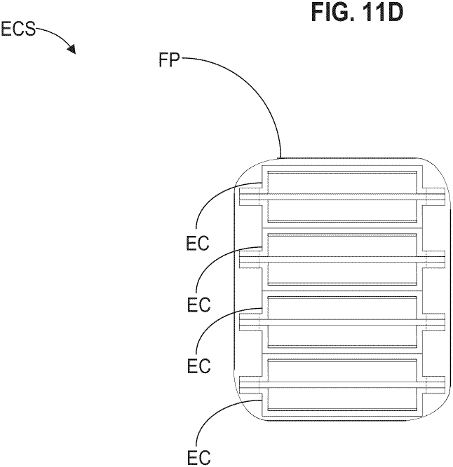

FIGS. 11A-11D are illustrations of a method 1100 of recycling electrode materials and various aspects thereof, according to an embodiment. FIGS. 11A-11B illustrate various aspects of the method 1100, while FIG. 11C shows detail of an electrochemical cell EC and FIG. 11D shows detail of an electrochemical cell stack ECS. As shown, the electrochemical cell EC includes an anode A disposed on an anode current collector ACC, a cathode C disposed on a cathode current collector CCC, and a separator S disposed between the anode A and the cathode C. The separator contacts a pouch P (i.e., a cell pouch) at a sealing region SR around the outside edges of the anode A and the cathode C.

As shown, the electrochemical cell EC is placed onto a conveyor 1149 and a cutting device 1132 cuts portions of the separator S and the pouch P (including all or part of the sealing region SR) from the electrochemical cell EC. After the cutting, cut scraps CS are separated from the electrochemical cell EC, sorted, and transported to a collection area 1134a via robotic arm 1133a. The anode A is then removed from the electrochemical cell EC and a robotic arm 1133b transports the anode A to a collection area 1134b. The separator S is then removed from the cathode S and a robotic arm 1133c transports the separator S to a collection area 1134c. The cathode C (and the cathode current collector CCC) are then conveyed to an ultrasonication conveyor 1151. As shown, the ultrasonication conveyor 1151 is angled downward with respect to the conveyor 1149.

In some embodiments, the ultrasonic conveyor 1151 can have a downward angle of at least about 0°, at least about 5°, at least about 10°, at least about 15°, at least about 20°, at least about 25°, at least about 30°, at least about 35°, at least about 40°, or at least about 45°. In some embodiments, the ultrasonic conveyor 1151 can have a downward angle of no more than about 50°, no more than about 45°, no more than about 40°, no more than about 35°, no more than about 30°, no more than about 25°, no more than about 20°, no more than about 15°, no more than about 10°, or no more than about 5°. Combinations of the above-referenced angles are also possible (e.g., at least about 0° and no more than about 50° or at least about 20° and no more than about 40°), inclusive of all values and ranges therebetween. In some embodiments, the ultrasonic conveyor 1151 can have a downward angle of about 0°, about 5°, about 10°, about 15°, about 20°, about 25°, about 30°, about 35°, about 40°, about 45°, or about 50°. In some embodiments, the ultrasonic conveyor 1151 can be horizontal or substantially horizontal. In other words, the ultrasonic conveyor 1151 can have a downward angle of about 0°. In some embodiments, the ultrasonic conveyor 1151 can have a downward angle of less than about 20°, less than about 15°, less than about 10°, or less than about 5°.

As shown, the ultrasonic conveyor 1151 includes walls or ledges that trap liquid L in vessels or bins. The cathode C is placed into one of the vessels and an ultrasonic probe 1135 sends an ultrasonic pulse to the cathode C to separate the cathode C from the cathode current collector CCC. The liquid L (e.g., IPA) facilitates this separation. Multiple ultrasonic probes 1135 can provide additional power to separate the cathode C from the cathode current collector CCC. As shown, two ultrasonic probes 1135 are installed adjacent to the ultrasonic conveyor 1151. In some embodiments, about 3, about 4, about 5, about 6, about 7, about 8, about 9, about 10, or at least about 10 ultrasonic probes 1135 can be installed adjacent to the ultrasonic conveyor 1151 to provide an ultrasonic pulse to the cathode C. In some embodiments, the ultrasonic probe 1135 can include an ultrasonic welding horn.

Upon reaching the end of the ultrasonic conveyor 1151, a robotic arm 1133d retrieves a solid portion of cathode C from the liquid L and transports it to a collection vessel 1136. From the collection vessel 1136, the cathode C can be transported for further processing. At the bottom of the ultrasonic conveyor 1151, the liquid L and residual cathode C falls into a slurry collection vessel 1137. In the slurry collection vessel 1137, the cathode C and liquid L separate into two or more phases. At the bottom of the slurry collection vessel 1137, a slurry SL collects, while a liquid phase forms on the top of the slurry collection vessel 1137. The liquid phase is then recycled via a pump 1138 back to the top of the ultrasonic conveyor 1151, where it is fed to the vessels in the ultrasonic conveyor 1151. The slurry SL can then be subject to further processing (e.g., separation of active material from conductive material).

FIG. 11D shows a series of electrochemical cells EC arranged in an electrochemical cell stack ECS. As shown, the electrochemical cells EC are stacked and housed in a formed pouch FP (also referred to herein as a “stack pouch”). The formed pouch FP houses a series of electrochemical cells EC. In some embodiments, the formed pouch FP can include aluminum. In some embodiments, the formed pouch FP can provide some structural rigidity to the electrochemical cell stack ECS. In some embodiments, the formed pouch FP can include a polymer. Within one formed pouch FP, an electrochemical cell stack ECS can include one or more electrochemical cells EC. As shown, the electrochemical cell stack ECS includes four electrochemical cells EC. In some embodiments, the electrochemical cell stack ECS can include about 1, about 2, about 3, about 4, about 5, about 6, about 7, about 8, about 9, about 10, about 15, about 20, about 25, about 30, about 35, about 40, about 45, about 50, about 55, about 60, about 65, about 70, about 75, about 80, about 85, about 90, about 95, about 100, about 200, about 300, about 400, about 500, about 600, about 700, about 800, about 900, about 1,000, or at least about 1,000 electrochemical cells EC, inclusive of all values and ranges therebetween.

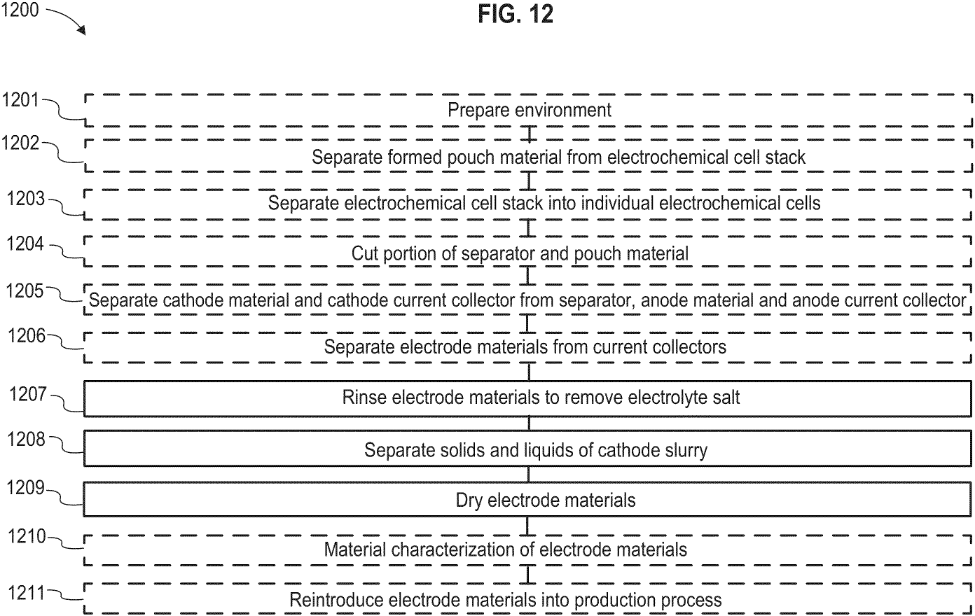

FIG. 12 is a block diagram of a method 1200 of recycling electrode materials, according to an embodiment. As shown, the method 1200 optionally includes preparing an environment at step 1201, separating a formed pouch material from an electrochemical cell stack at step 1202, separating the electrochemical cell stack into individual electrochemical cells at step 1203, cutting a portion of the separator and the pouch material at step 1204, separating a cathode material and cathode current collector from a separator, anode material and anode current collector at step 1205, and separating the electrode materials (i.e., anode material and cathode material) from their respective current collectors at step 1206. The method 1200 further includes rinsing the electrode materials to remove electrolyte salt at step 1207, separating solids and liquids of the cathode slurry at step 1208, and drying the electrode materials at step 1209. The method 1200 optionally includes material characterization of the electrode materials at step 1210 and reintroducing the electrode materials into an electrochemical cell production process at step 1211.

Step 1201 is optional and includes preparing an environment for recycling. In some embodiments, preparing the environment can include measuring atmospheric composition and moisture content in the environment where the recycling is to occur. In some embodiments, step 1201 can include cleaning the equipment used in the recycling. In some embodiments, step 1201 can include preventive maintenance on equipment used in the recycling.

Step 1202 is optional and includes separating the formed pouch (i.e., stack pouch) material from the electrochemical cell stack. In some embodiments, the separation can include cutting a portion of a pouch that houses the electrochemical cell stack and removing the electrochemical cell stack from the pouch. In some embodiments, the pouch can include aluminum. In some embodiments, at least a portion of the aluminum from the pouch can be recycled. In some embodiments, at least a portion of the aluminum or other materials from the pouch can be scrapped.

Step 1203 is optional and includes singularly separating unit cells from the electrochemical cell stack. In some embodiments, the unit cells can include assembled pouch cells that have not yet been through a formation pre-charge step. In some embodiments, the separation of the individual unit cells can be manual. In some embodiments, the separation of the individual unit cells can be automated. In some embodiments, the separation of the individual unit cells can be via a robotic arm. In some embodiments, the separation of the individual unit cells can be via a blade.

Step 1204 is optional and includes cutting a portion of a pouch material. In some embodiments, the pouch material can be part of a formed pouch or a stack pouch. In some embodiments, the pouch material can include aluminum. In some embodiments, the cutting can be via laser cutting. In some embodiments, the cutting can be via die pressing. In some embodiments, the cutting can be via manual cutting. In some embodiments, the manual cutting can be via scissors and/or a knife. In some embodiments, the cutting can be automated.

Step 1205 includes separating the cathode material and the cathode current collector from the separator, the anode material, and the anode current collector. In some embodiments, the separating can be mechanical. In some embodiments, the cathode material can include a semi-solid electrode material. In some embodiments, the anode material can include a semi-solid electrode material. In some embodiments, the cathode material can be binderless. In some embodiments, the anode material can be binderless. In some embodiments, the peeling can be via a blade. In some embodiments, the peeling can be via a wedge. In some embodiments, the mechanical separation can include peeling.

In some embodiments, the semi-solid electrode material can include at least about 1 wt%, at least about 2 wt%, at least about 3 wt%, at least about 4 wt%, at least about 5 wt%, at least about 6 wt%, at least about 7 wt%, at least about 8 wt%, at least about 9 wt%, at least about 10 wt%, at least about 15 wt%, at least about 20 wt%, at least about 25 wt%, at least about 30 wt%, at least about 35 wt%, at least about 40 wt%, or at least about 45 wt% liquid electrolyte. In some embodiments, the semi-solid electrode material can include no more than about 50 wt%, no more than about 45 wt%, no more than about 40 wt%, no more than about 35 wt%, no more than about 30 wt%, no more than about 25 wt%, no more than about 20 wt%, no more than about 15 wt%, no more than about 10 wt%, no more than about 9 wt%, no more than about 8 wt%, no more than about 7 wt%, no more than about 6 wt%, no more than about 5 wt%, no more than about 4 wt%, no more than about 3 wt%, or no more than about 2 wt% liquid electrolyte. Combinations of the above-referenced percentages are also possible (e.g., at least about 1 wt% and no more than about 50 wt% or at least about 5 wt% and no more than about 25 wt%), inclusive of all values and ranges therebetween. In some embodiments, the semi-solid electrode material can include about 1 wt%, about 2 wt%, about 3 wt%, about 4 wt%, about 5 wt%, about 6 wt%, about 7 wt%, about 8 wt%, about 9 wt%, about 10 wt%, about 15 wt%, about 20 wt%, about 25 wt%, about 30 wt%, about 35 wt%, about 40 wt%, about 45 wt%, or about 50 wt% liquid electrolyte.

In some embodiments, the cathode material can include cathode active powder, cathode conductive powder, and/or a cathode slurry mix. In some embodiments, the cathode material can come from a cathode slurry cartridge filling station, a cathode slurry cartridge purging station, a cathode slurry casting station, a cathode slurry electrode inspection station, a unit cell assembly station, and/or a pouch cell assembly station.

Step 1206 is optional and includes separating the electrode materials from their respective current collectors. In some embodiments, the method 1200 can include further processing of only the anode. In some embodiments, the method 1200 can include further processing of only the cathode. In some embodiments, the method 1200 can include further processing of both the anode and the cathode. In some embodiments, the electrode materials can be pre-dried before separating the electrode materials from their respective current collectors. In some embodiments, step 1206 can include separating only the anode material from the anode current collector. In some embodiments, step 1206 can include separating only the cathode material from the cathode current collector. In some embodiments, step 1206 can include separating the anode material from the anode current collector and separating the cathode material from the cathode current collector. In some embodiments, separation of the electrode materials from the current collectors can include immersing the electrode materials and the current collectors in a solvent bath and applying an ultrasonic probe to the solvent. In some embodiments, the ultrasonic probe can include an ultrasonic welding horn. In some embodiments, separation of the electrode materials from the current collectors can include immersing the electrode materials and the current collectors in one or more solvent baths and stimulating the electrode materials and the current collectors via one or more ultrasonic probes. In some embodiments, separation of the electrode materials from the current collectors can include mechanical separation (e.g., via a wedge and/or a peeler). In some embodiments, the electrode materials can be removed from the current collectors in a stirred tank. In some embodiments, the electrode materials can be removed from the current collectors via a jet nozzle. In some embodiments, the electrode materials can be removed from the current collectors via mechanical separation (e.g., via a brush and/or a wedge).

Step 1207 includes rinsing the electrode materials with solvent to remove the electrolyte components. In some embodiments, step 1207 can include dissolving and separating the electrolyte components from the other electrode materials. Removal of the electrolyte components from the other electrode materials is enabled via the use of binderless electrode materials. The lack of binder improves the ease of separation of the electrolyte from the other electrode materials. In some embodiments, the electrolyte components can include electrolyte salt, electrolyte additives, and/or electrolyte solvent. In some embodiments, the electrolyte solvent can be added to the electrode materials while the electrode materials are still attached to the current collectors. In some embodiments, the electrolyte solvent can be added to the electrode materials in a stirred tank, an ultrasonic bath, a counterflow column, or any combination thereof.

In some embodiments, the method 1200 can include separating active material in the electrode materials from conductive material in the electrode materials. In some embodiments, the separation of the active material from the conductive material can be via a liquid-solid separation method. In some embodiments, the separation of the active material from the conductive material can be via a hydrocyclone, a froth flotation tank, a centrifuge, a settling tank, or a filter. In some the separation of the active material from the conductive material can be via a liquid-liquid separation method. In some embodiments, the separation of the active material from the conductive material can be via distillation.

Step 1208 includes separating the solids and the liquids of the cathode material/solvent mixture. In some embodiments, the separation can be via centrifugation. In some embodiments, the separation can be via a sedimentation tank. After separating the solids from the liquids, the solvent and the electrolyte salt can be drained or pumped away from the settling tank to isolate the solids.

Step 1209 includes drying the electrode materials to form electrode powders. In some embodiments, the drying can be via an oven or furnace. In some embodiments, the drying can include vacuum drying. In some embodiments, the active materials can be separated from the conductive materials after the drying. In some embodiments, the active materials can be separated from the conductive materials before the drying via magnetic separation. In some embodiments, liquid-solid separation can occur via centrifugation. In some embodiments, the drying can be via a heated conveying screw. In some embodiments, the active materials can be separated from the conductive materials via solid-solid separation. In some embodiments, the solid-solid separation can include cyclone separation, air classification, and/or magnetic separation.

Step 1210 is optional and includes material characterization of electrode powders. In some embodiments, step 1210 can include lab analysis and specification compliance of electrode powders. In some embodiments, the material characterization can include conductivity and rheological yield stress testing of the electrode materials. In some embodiments, materials that do not meet desired criteria can be processed further (e.g., via steps 1201-1209).

Step 1211 is optional and includes reintroducing the electrode powders into an electrochemical cell production process. In some embodiments, step 1211 can include mixing the electrode powders with fresh electrode materials. In some embodiments, the mixing can be via a low shear blend process, a V-blend process, a mill, and/or a ribocone dryer/blender. In some embodiments, the mixing can be at a ratio (mass:mass) of at least about 5:95, at least about 10:90, at least about 15:85, at least about 20:80, at least about 25:75, at least about 30:70, at least about 35:65, at least about 40:60, at least about 45:55, at least about 50:50, at least about 55:45, at least about 60:40, at least about 65:35, at least about 70:30, at least about 75:25, at least about 80:20, at least about 85:15, or at least about 90:10 recycled electrode material to fresh electrode material. In some embodiments, the mixing can be at a ratio of no more than about 95:5, no more than about 90:10, no more than about 85:15, no more than about 80:20, no more than about 75:25, no more than about 70:30, no more than about 65:35, no more than about 60:40, no more than about 55:45, no more than about 50:50, no more than about 45:55, no more than about 40:60, no more than about 35:65, no more than about 30:70, no more than about 25:75, no more than about 20:80, no more than about 15:85, or no more than about 10:90 recycled electrode material to fresh electrode material. Combinations of the above-referenced ratios are also possible (e.g., at least about 5:95 and no more than about 95:5 or at least about 10:90 and no more than about 30:70), inclusive of all values and ranges therebetween. In some embodiments, the mixing can be at a ratio of about 5:95, about 10:90, about 15:85, about 20:80, about 25:75, about 30:70, about 35:65, about 40:60, about 45:55, about 50:50, about 55:45, about 60:40, about 65:35, about 70:30, about 75:25, about 80:20, about 85:15, about 90:10, or about 95:5 recycled electrode material to fresh electrode material. In some embodiments, pure or substantially pure recycled electrode material can be used in a cell production process.

In some embodiments, the ratio (mass:mass) of active materials to conductive materials can be tuned and adjusted in the reintroduced electrode materials. In some embodiments, the ratio of active materials to conductive materials can be at least about 10:1, at least about 20:1, at least about 30:1, at least about 40:1, at least about 50:1, at least about 60:1, at least about 70:1, at least about 80:1, at least about 90:1, at least about 100:1, or at least about 150:1. In some embodiments, the ratio of active materials to conductive materials can be no more than about 200:1, no more than about 150:1, no more than about 100:1, no more than about 90:1, no more than about 80:1, no more than about 70:1, no more than about 60:1, no more than about 50:1, no more than about 40:1, no more than about 30:1, no more than about 20:1. Combinations of the above-referenced ratios are also possible (e.g., at least about 10:1 and no more than about 200:1 or at least about 50:1 and no more than about 100:1). In some embodiments, the ratio of active materials to conductive materials can be about 10:1, about 20:1, about 30:1, about 40:1, about 50:1, about 60:1, about 70:1, about 80:1, about 90:1, about 100:1, about 150:1, or about 200:1.

### EXAMPLES

### Example 1

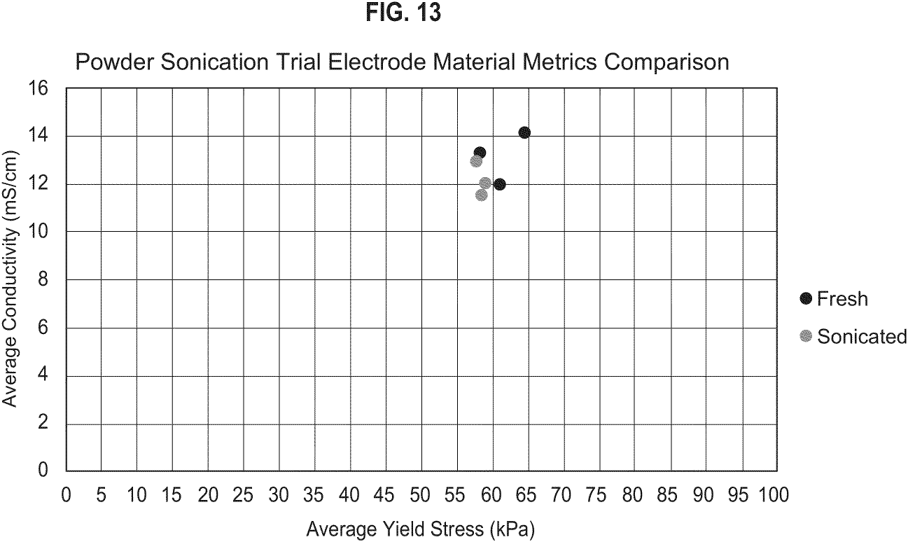

An experiment was developed to compare the effects of targeted ultrasonication via an ultrasonic welding bar on fresh electrode powders that have not been subject to a slurry production process. The control group underwent the same material handling (soaked in IPA, multiple container transfers, oven drying, spatula breakdown, and acoustic mixing) as the sonicated group, except for the sonication step. Experimental data in FIG. 13 showed very similar slurry metrics (conductivity and yield stress averages), with no data outliers for either group. This supports a conclusion that standard run time targeted ultrasonication does not break down a conductive carbon network. In other words, the most aggressive step of the recycling process does not damage the conductive material such that the slurry’s performance metrics are compromised.

### Example 2

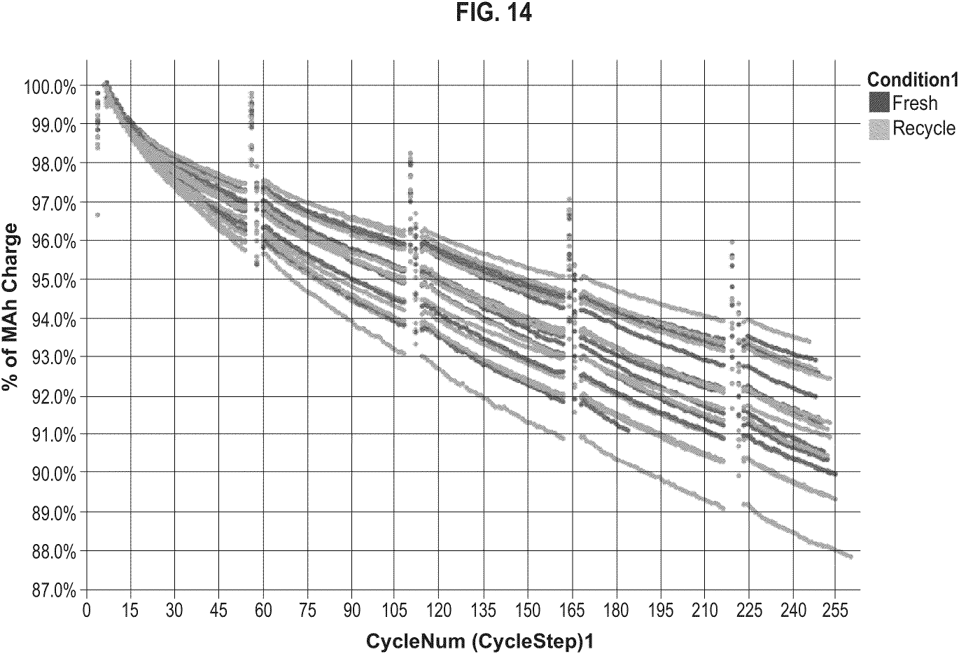

Electrochemical cells were produced using fresh electrode materials and compared to electrochemical cells produced using 20 wt% recycled electrode materials (formed via the process described in FIG. 12). FIG. 14 shows the charge capacity of the electrochemical cells normalized to the charge capacities of the first cycles. Table 1 shows conductivity and yield stress data of fresh cathode powder electrode material and 20 wt% recycled cathode powder electrode material. As shown, losses in conductivity and yield stress are minimal for recycled electrode material.

TABLE 1

Conductivity and Yield Stress Data for Fresh vs. Recycled Cathode Powder

| Electrode Material Condition | Average Conductivity (mS/cm) | Avg. Yield Stress (kPa) |
|---|---|---|
| Fresh Cathode Powder Electrode Material | 15.7 | 58 |
| 20% Recycled Cathode Powder Electrode Material | 15.4 | 49.9 |

Various concepts may be embodied as one or more methods, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments. Put differently, it is to be understood that such features may not necessarily be limited to a particular order of execution, but rather, any number of threads, processes, services, servers, and/or the like that may execute serially, asynchronously, concurrently, in parallel, simultaneously, synchronously, and/or the like in a manner consistent with the disclosure. As such, some of these features may be mutually contradictory, in that they cannot be simultaneously present in a single embodiment. Similarly, some features are applicable to one aspect of the innovations, and inapplicable to others.

In addition, the disclosure may include other innovations not presently described. Applicant reserves all rights in such innovations, including the right to embodiment such innovations, file additional applications, continuations, continuations-in-part, divisionals, and/or the like thereof. As such, it should be understood that advantages, embodiments, examples, functional, features, logical, operational, organizational, structural, topological, and/or other aspects of the disclosure are not to be considered limitations on the disclosure as defined by the embodiments or limitations on equivalents to the embodiments. Depending on the particular desires and/or characteristics of an individual and/or enterprise user, database configuration and/or relational model, data type, data transmission and/or network framework, syntax structure, and/or the like, various embodiments of the technology disclosed herein may be implemented in a manner that enables a great deal of flexibility and customization as described herein.

All definitions, as defined and used herein, should be understood to control over dictionary definitions, definitions in documents incorporated by reference, and/or ordinary meanings of the defined terms.

As used herein, in particular embodiments, the terms “about” or “approximately” when preceding a numerical value indicates the value plus or minus a range of 10%. Where a range of values is provided, it is understood that each intervening value, to the tenth of the unit of the lower limit unless the context clearly dictates otherwise, between the upper and lower limit of that range and any other stated or intervening value in that stated range is encompassed within the disclosure. That the upper and lower limits of these smaller ranges can independently be included in the smaller ranges is also encompassed within the disclosure, subject to any specifically excluded limit in the stated range. Where the stated range includes one or both of the limits, ranges excluding either or both of those included limits are also included in the disclosure.

The phrase “and/or,” as used herein in the specification and in the embodiments, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the embodiments, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the embodiments, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.” “Consisting essentially of,” when used in the embodiments, shall have its ordinary meaning as used in the field of patent law.

As used herein in the specification and in the embodiments, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the embodiments, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

While specific embodiments of the present disclosure have been outlined above, many alternatives, modifications, and variations will be apparent to those skilled in the art. Accordingly, the embodiments set forth herein are intended to be illustrative, not limiting. Various changes may be made without departing from the spirit and scope of the disclosure. Where methods and steps described above indicate certain events occurring in a certain order, those of ordinary skill in the art having the benefit of this disclosure would recognize that the ordering of certain steps may be modified and such modification are in accordance with the variations of the invention. Additionally, certain of the steps may be performed concurrently in a parallel process when possible, as well as performed sequentially as described above. The embodiments have been particularly shown and described, but it will be understood that various changes in form and details may be made.

1. A method of recycling electrode materials, the method comprising:
separating a stack pouch material from an electrochemical cell stack;
separating a plurality of unit cells from the electrochemical cell stack into individual unit cells;
cutting within a heat seal of a cell pouch of a unit cell from the plurality of unit cells;
separating a cathode material and a cathode current collector away from a separator, an anode material, and an anode current collector of the unit cell;
placing the cathode material and the cathode current collector in a solvent bath with the cathode current collector facing downward;
separating the cathode material from the cathode current collector via an ultrasonic probe;
separating solids and liquids of the cathode material;
drying the solids of the cathode material; and
incorporating the solids of the cathode material into a new cathode mixture.

2. The method of claim 1, further comprising:
before separating the solids and liquids of the cathode material, mixing the cathode material with a solvent in a mixing tank.

3. The method of claim 1, further comprising:
preparing an environment for the recycling of the electrode materials, the preparing including:
measuring moisture content and particulate content of the environment; and
cleaning all equipment used for the recycling.

4. The method of claim 1, further comprising:
unjoining current collector tabs from current collectors of the unit cells.

5. The method of claim 1, further comprising:
measuring a moisture content of the solids.

6. The method of claim 1, wherein the cathode material is a semi-solid, binderless cathode material.

7. The method of claim 1, wherein separating the cathode material and the cathode current collector away from the separator, the anode material, and the anode current collector includes peeling.

8. The method of claim 1, wherein separating the solids and the liquids of the cathode material is via at least one of centrifugation or filtration.

9. The method of claim 1, wherein the ultrasonic probe includes an ultrasonic welding horn.

10. A method of recycling electrode materials, the method comprising:
separating a stack pouch material from an electrochemical cell stack;
separating a plurality of unit cells from the electrochemical cell stack into individual unit cells;
cutting within a heat seal of a cell pouch of a unit cell from the plurality of unit cells;
separating an anode material and an anode current collector away from a separator, a cathode material, and a cathode current collector of the unit cell;
placing the anode material and the anode current collector in a solvent bath with the anode current collector facing downward;
separating the anode material from the anode current collector via an ultrasonic probe;
separating solids and liquids of the anode material;
drying the solids of the anode material; and
incorporating the solids of the anode material into a new anode mixture.

11. The method of claim 10, further comprising:
before separating the solids and liquids of the cathode material, mixing the cathode material with a solvent in a mixing tank.

12. The method of claim 10, further comprising:
preparing an environment for the recycling of the electrode materials, the preparing including:
measuring moisture content and particulate content of the environment; and
cleaning all equipment used for the recycling.

13. The method of claim 10, further comprising:
unjoining current collector tabs from current collectors of the unit cells.

14. The method of claim 10, further comprising:
measuring a moisture content of the solids.

15. The method of claim 10, wherein the anode material is a semi-solid, binderless anode material.

16. The method of claim 10, wherein separating the anode material and the anode current collector away from the separator, the cathode material, and the cathode current collector includes peeling.

17. The method of claim 10, wherein separating the solids and the liquids of the anode material is via at least one of centrifugation or filtration.

18. The method of claim 10, wherein the ultrasonic probe includes an ultrasonic welding horn.

19. A method, comprising:
cutting a portion of a stack pouch material;
separating the stack pouch material from a series of individual electrochemical cells;
separating electrodes of the individual electrochemical cells from separators of the individual electrochemical cells, the electrodes including a semi-solid anode material coupled to an anode current collector and a semi-solid cathode material coupled to a cathode current collector, the semi-solid anode material and the semi-solid cathode material having binderless compositions;
separating the semi-solid anode material from the anode current collector;
separating the semi-solid cathode material from the cathode current collector;
rinsing the semi-solid anode material and the semi-solid cathode material with one or more solvents to remove electrolyte components from the semi-solid anode material and the semi-solid cathode material;
drying the anode material to form an anode powder; and
drying the cathode material to form a cathode powder.

20. The method of claim 19, further comprising:
reintroducing at least one of the anode powder or the cathode powder into an electrochemical cell production process.

21. The method of claim 19, wherein cutting the portion of the stack pouch material is via at least one of laser cutting, die pressing, or manual cutting.

22. The method of claim 19, wherein separating electrodes of the individual electrochemical cells from separators of the individual electrochemical cells is via at least one of laser cutting, die pressing, or manual cutting.

23. The method of claim 19, wherein separating the semi-solid cathode material from the cathode current collector and/or separating the semi-solid anode material from the anode current collector is via at least one of ultrasonication, stirred tank agitation, jet nozzle agitation, mechanical removal via a brush, or mechanical removal via a wedge.

24. The method of claim 19, further comprising:
separating the anode powder into an active powder and a conductive powder and/or separating the cathode powder into an active powder and a conductive powder via at least one of a cyclone, an air classifier, a magnetic separator, or a froth flotation tank.

25. The method of claim 20, further comprising:
performing material characterization of the anode powder and/or the cathode powder.

26. The method of claim 20, wherein reintroducing the anode powder and/or the cathode powder into the electrochemical cell production process includes mixing the anode powder and/or the cathode powder with fresh electrode materials in a ratio of between about 10:90 and about 30:70 recycled electrode materials to fresh electrode materials.

27-63. (canceled)
